(19) United States
(12) Patent Application Publication
(10) Pub. No.: US 2005/0165808 A1
(43) Pub. Date: Jul. 28, 2005

(54) Information processing apparatus for retrieving data having one or more attributes

(76) Inventors: Yohko Ohtani, Tokyo (JP); Junichi Minato, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/023,480

(22) Filed: Dec. 29, 2004

(30) Foreign Application Priority Data
Jan. 5, 2004 (JP) 2004-000249

(51) Int. Cl. G06F 7/00

(52) U.S. Cl. 707/100

(57) ABSTRACT

An information processing apparatus is disclosed, including: a retrieving unit configured to retrieve data from an external information storage server; a setting unit configured to set a plurality of attributes so that said retrieving unit retrieves the plurality of attributes from the external information storage server; and a converting unit configured to convert the data structure of the retrieved data into a data structure corresponding to the plurality of attributes. When data having one or more attributes is retrieved from the information storage server, the attributes are set so that the attributes of the data are obtained from the information storage server. Remaining attributes of the data is not retrieved to reduce processing time required for the data retrieval.

### BACKGROUND OF THE INVENTION

1. Field of the Invention

The present invention generally relates to an information processing apparatus and a method of retrieving data, and more particularly, to an information processing apparatus for and a method of retrieving data having one or more attributes from an external information storage server.

2. Description of the Related Art

In a system comprising one or more information processing apparatuses (hereinafter called clients) and an information storage server mutually connected via a network, a client is often required to access the information storage server for retrieving an item of data containing one or more attributes stored in the information storage server. Japanese Laid-Open Patent Application No. 2003-108558 for example discloses a data retrieval system including a client terminal and a data server connected via a network in which the client terminal can retrieve data from the data server.

An information storage server may comply with LDAP (Lightweight Directory Access Protocol). In the following description, such a server may be referred to as a LDAP server.

A LDAP server can store various data such as text data and binary data. The data stored (and managed) in the LDAP server may contain one or more attributes. The attributes of data may be defined by RFC (Request For Comments) and/or defined specifically for the LDAP server. Each item of data stored in the LDAP server may change item by item.

The LDAP server in accordance with LDAP version 3 defined by RFC 2251 will provide a schema list to any client, the schema list being a list of description (hereinafter called schema) of the attributes of data stored in the LDAP server.

An example of the client is an image processing apparatus in which the functions of a printer, a copier, a facsimile machine, and a scanner are embedded in a single system. The image processing apparatus is provided with functional units such as a display unit, a print unit, and an image capture unit in its chassis, and also provided with software programs each corresponding to a printer, a copier, a facsimile machine, and a scanner. By selecting one of the software programs, the image processing apparatus operates as selected one of the printer, the copier, the facsimile machine, and the scanner. Japanese Laid-Open Patent Application No. 2002-84383 discloses such an image processing apparatus as a client connected to a network.

A client may not able to obtain the schema list from the LDAP server due to mismatch of the version of the LDAP server and/or implementation format. Even if the client obtains the schema list from the LDAP server, the schema list may be incorrect and includes erroneous description of the attributes and size of the data stored in the LDAP server. In such a case, the client fails to accurately estimate time required for obtaining the data from the LDAP server and memory capacity required for storing the data.

This results in a problem that the client requires longer time than expected to obtain data from the LDAP server, process the obtained data, and display the processed data. Another problem of the related art may be, in the case in which the data obtained from the LDAP server is binary, the client may still encode the obtained data in the same manner where text data is encoded.

### SUMMARY OF THE INVENTION

Accordingly, it is a general object of the present invention to provide a novel and useful information storage apparatus and a method of retrieving data in which at least one of the above problems is eliminated.

Another and more specific object of the present invention is to provide a information processing apparatus and a method of retrieving data in which data can be retrieved in a short processing time.

To achieve at least one of the above objects, an information processing apparatus, includes:
a retrieving unit configured to retrieve data from an external information storage server;
a setting unit configured to set a plurality of attributes so that said retrieving unit retrieves the plurality of attributes from the external information storage server; and
a converting unit configured to convert the data structure of the retrieved data into a data structure corresponding to the plurality of attributes.

According to another aspect of the present invention, a method of retrieving data stored in an external information storage server, and the method includes the steps of:
setting a plurality of attributes of the data so that the plurality of attributes is retrieved from the external information storage server;
retrieving the data from the information storage server; and
converting the data structure of the retrieved data into a data structure corresponding to the plurality of attributes.

According to yet another aspect of the present invention, a computer readable recording medium is provided that stores a computer program that, when executed by a computer, causes the computer to retrieve data stored in an external information storage server, and the computer program includes the steps of:
setting a plurality of attributes of the data so that the plurality of attributes is retrieved from the external information storage server;
retrieving the data from the information storage server; and
converting the data structure of the retrieved data into a data structure corresponding to the plurality of attributes.

According to the present invention, when data having one or more attributes is retrieved from an information storage server, the attributes are set so that the attributes of the data are obtained from the information storage server. That is, a subset of the attributes of the data can be set so that the subset is not retrieved.

For example, if only attributes that requires short processing time are set as those to be obtained from the information storage server, the processing time required for the data retrieval from the information storage server can be reduced. That is, if attributes that requires long processing time is set as the subset that is not retrieved from the information storage server, the processing time required for the data retrieval can be reduced.

Other objects, features, and advantages of the present invention will become more apparent from the following detailed description when read in conjunction with the accompanying drawings.

### BRIEF DESCRIPTION OF THE DRAWINGS

FIG. 1 is a schematic diagram showing the software structure of a multifunctional peripheral according to an embodiment of the present invention;

FIG. 2 is a schematic diagram showing the hardware structure of a multifunctional peripheral according to an embodiment of the present invention;

FIG. 3 is a schematic diagram for explaining requests for obtaining, adding, changing, and deleting information stored in a LDAP server;

FIG. 4 is a schematic diagram for explaining the software configuration of UCS that embodies a retrieving function according to an embodiment of the present invention;

FIG. 5 is a sequence diagram showing an example of LDAP retrieval according to an embodiment of the present invention;

FIG. 6 is a diagram showing the data structure of a result of LDAP retrieval according to an embodiment of the present invention;

FIG. 7 is a diagram showing the data structure of exemplary LDAP user information according to an embodiment of the present invention;

FIG. 8 is a flowchart showing an exemplary process for converting the data structure of each LDAP retrieval result to that of an entry for a multifunctional peripheral according to an embodiment of the present invention;

FIG. 9 is a schematic diagram for explaining the software configuration of UCS that embodies retrieving function according to an embodiment of the present invention;

FIG. 10 is a flowchart showing an exemplary process for measuring time required for converting the data structure of each LDAP retrieval result to that of an entry for a multifunctional peripheral according to an embodiment of the present invention;

FIG. 11 is a sequence diagram showing a first exemplary process of LDAP retrieval according to an embodiment of the present invention;

FIG. 12 is a schematic diagram showing an exemplary screen of processing time according to an embodiment of the present invention;

FIG. 13 is a schematic diagram showing an exemplary screen of LDA retrieval results according to an embodiment of the present invention;

FIG. 14 is a sequence diagram showing a second exemplary process of LDAP retrieval according to an embodiment of the present invention;

FIG. 15 is a schematic diagram showing the transition of screens in the case of the second exemplary process according to an embodiment of the present invention;

FIG. 16 is a sequence diagram showing an exemplary process for setting information in a LDAP server according to an embodiment of the present invention;

FIG. 17 is a schematic diagram showing the transition of screens in the case of a third exemplary process of LDAP retrieval according to an embodiment of the present invention;

FIG. 18 is a sequence diagram showing an exemplary process for setting attribute according to an embodiment of the present invention;

FIG. 19 is a sequence diagram showing an exemplary process for setting information in a LDAP server according to an embodiment of the present invention;

FIG. 20 is a sequence diagram showing an exemplary process for setting information in a LDAP server according to an embodiment of the present invention;

FIG. 21 is a schematic diagram for explaining the software configuration of UCS that embodies retrieving function according to an embodiment of the present invention;

FIG. 22 is a schematic diagram showing the transition of screens in the case of sixth exemplary process of LDAP retrieval according to an embodiment of the present invention;

FIG. 23 is a sequence diagram showing seventh exemplary process of LDAP retrieval according to an embodiment of the present invention;

FIG. 24 is a schematic diagram for explaining the difference between an initial retrieval result and a retrieval result obtained later according to an embodiment of the present invention; and

FIG. 25 is a sequence diagram showing eighth exemplary process of LDAP retrieval according to an embodiment of the present invention.

### DETAILED DESCRIPTION OF THE PREFERRED EMBODIMENTS

The preferred embodiments of the present invention are described in detail below with reference to the drawings. An image processing apparatus is described below as an example of the client. The image processing apparatus accommodates the functions of a printer, a copier, a facsimile machine, and a scanner, and therefore may be referred to as a multifunctional peripheral (MFP) in the following description.

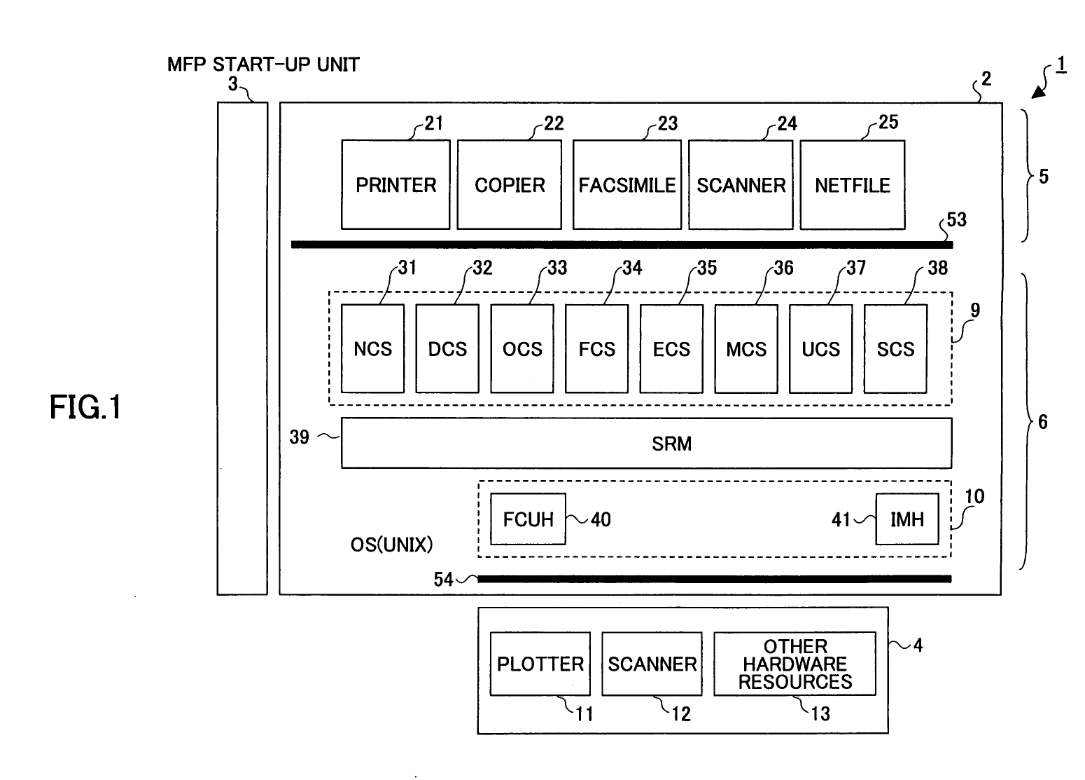

FIG. 1 is a schematic diagram showing an exemplary multifunctional peripheral (MFP) according to an embodiment, for explaining its software configuration. The MFP 1 includes software programs 2, a MFP start-up unit 3, and hardware resources 4.

The hardware resources 4 includes a plotter 11, a scanner 12, and other hardware resources 13 such as a facsimile machine. The software programs 2 has an application layer 5 that are operative on an operating system (hereinafter, referred to as OS) such as UNIX (registered trade mark) and a platform 6.

The application layer 5 includes software programs each dedicated for a specific user service such as printing, copying, facsimile communication, and scanning. The application layer 5 of FIG. 1 includes printer application 21, copier application 22, facsimile application 23, scanner application 24, and net file application 25. The net file application is an application for realizing network filing, which manages data communication with an external network device connected to the MFP 1 via the network.

Platform 6 includes control service layer 9, system resource manager (hereinafter referred to as SRM) 39, and handler layer 10. The control service layer 9 interprets a request for processing from the application layer 5, and issue a request for reserving the hardware resource 4. The SRM 39 manages one or more hardware resources 4, and arbitrates requests for reserving the hardware resources from the control service layer 9. The handler layer 10 manages the hardware resources 4 in response to a request for reserving the hardware resources 4 from the SRM 39.

The control service layer 9 includes one or more service modules such as NCS 31, DCS 32, OCS 33, FCS 34, ECS 35, MCS 36, UCS 37, and SCS 38. The platform 6 is configured to support API 53 that receives processing requests from the application layer 5 through a predetermined set of functions. The OS can concurrently execute multiple software programs included in the application layer 5 and the platform 6 as respective processes.

The process of NCS (Network Control Service) 31 intermediates between the network and each application thereby to transfer data received from the network in compliance with an appropriate protocol to appropriate application program, and vice versa. For example, NCS 31 controls data communication of MFP 1 with an external network device connected via the network.

The process of DCS (Delivery Control Service) 32 controls the delivery of document data, for example, stored in the MFP 1. As will be appreciated below, the process of OCS (Operations panel Control Service) 33 controls an operations panel provided to MFP 1.

The process of FCS (Facsimile Control Service) 34 provides API (Application Program Interface) used for the transmission and/or receipt of facsimile message via PSTN or ISDN network, the registration and reference of various facsimile data stored in backup memory unit, the reading of facsimile document, and the output of facsimile document, for example.

The process of ECS (Engine Control Service) 35 controls engine units such as the plotter 11, the scanner 12, and the hardware resources 13. The process of MCS (Memory Control Service) 36 controls the reservation and release of memory area, the use of a hard disk drive (HDD), and the compression/decompression of image data, for example. The process of UCS (User information Control Service) 37 manages the user information.

The process of SCS (System Control Service) 38 controls operations unit, the displaying of system screen, the indication of LED, the hardware resources, the application programs, and interrupt application programs, for example.

The process of SRM 39 cooperate with SCS 38 to control the system and the hardware resources 4. For example, the process of SRM 39, in response reservation requests from an upper rank layer for the hardware resource 4 such as the plotter 11 and scanner 12, arbitrates the reservation requests and controls the operation of the hardware resources 4.

Specifically, the process of SRM 39 determines whether the requested item of the hardware resources 4 is available (whether the requested item is under use in response to another reservation request), and if available, notify the upper rank layer that the requested item of the hardware resources 4 is available. The process of SRM 39, in response to the reservation request from the upper rank layer, schedules the user of requested item of the hardware resources 4, and directly causes the requested item to perform the request (for example, the paper transportation and image forming by the printer engine, the reservation of memory area, the generation of file).

The handler layer 10 includes FCUS (Facsimile Control Unit handler) 40 that controls FCU (Facsimile Control Unit) to be described below, and IMH (Image Memory Handler) 41 that allocates memory area to the processes and manages the memory area allocated to the processes. SRM 39 and FCUH 40 request the hardware resources 4 for processing, using the engine I/F (interface) 54 that transmits processing request to the hardware resources 4 through predefined functions.

The configuration of FIG. 1 allows MFP 1 to use the platform 6 to centrally control processing commonly required by the application programs. The hardware structure of MFP 1 is described below.

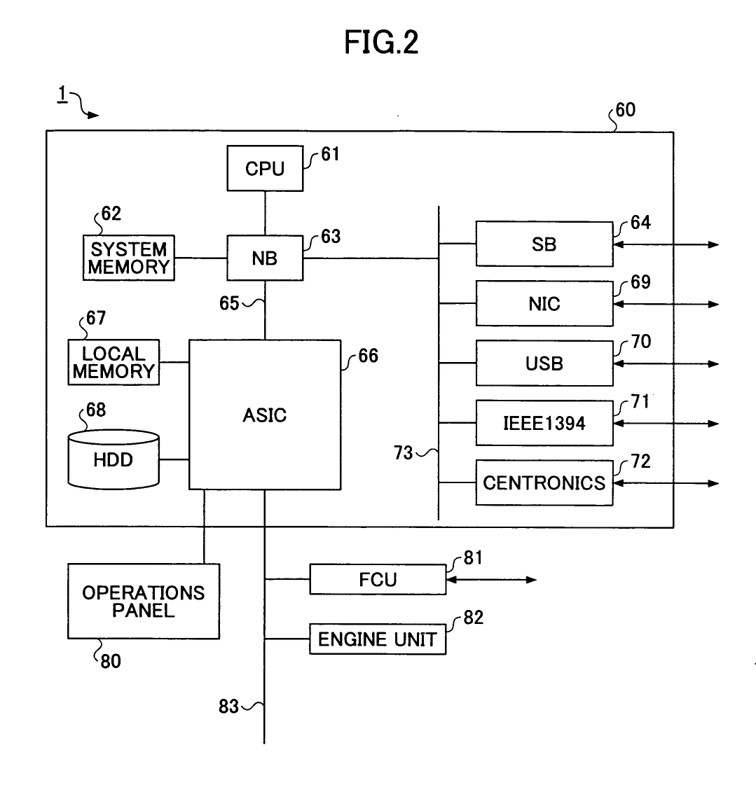

FIG. 2 is a schematic diagram of the hardware structure of MFP to which an exemplary embodiment of the present invention is applicable. MFP 1 shown in FIG. 2 includes a controller 60, an operations panel 80, FCU 81, and engine unit 82.

The controller 60 includes CPU 61, system memory 62, NB 63, SB 64, ASIC 66, local memory unit 67, HDD 68, NIC 69, USB I/F 70, IEEE 1394 I/F 71, and Centronics I/F 72.

The operations panel 80 is connected to the ASIC 66 of the controller 60. FCU 81 and the engine unit 82 are also connected to the ASIC 66 of the controller 60 via PCI bus 83.

Additionally, the local memory 67 and the HDD 68 are connected to the ASIC 66, and the ASIC 66 is connected to the CPU 61 via the NB 63, which is one of the chipsets associated with the CPU 61. The connection between the ASIC 66 and the NB 63 is AGP (Accelerated Graphics Port) 65, for example.

The CPU 61 controls the entire system of the MFP 1. As shown in FIG. 1, one or more service modules forming the control service layer 9, the SRM 39, the FCUH 40 and the IMH 41 forming the handler layer 10 are executed on the OS by the CPU 61, and then, the printer application 21, the copier application 22, the facsimile application 23, the scanner application 24, and the net file application 25 forming the application layer 5 are executed.

The NB (North Bridge) 63 is a bridge device for connecting the CPU 61, the system memory 62, the SB 64, the ASIC 66, the NIC 69, the USB I/F 70, the IEEE 1394 I/F 71, and the Centronics I/F 72. The NB 63 is connected with the SB 64, the NIC 69, the USB I/F 70, the IEEE 1394 I/F 71 and the Centronics I/F 72 via PCI bus 73. The SB (South Bridge) 64 is a bridge device for connecting the ROM and peripheral devices to the PCI bus 73.

The system memory 62 is used for storing image data to be rendered. The local memory 67 is used for buffering image data used by the copier function and code data, for example. The ASIC 66 is an application specific integrated circuit having various hardware elements for image processing, and is configured to process image data. The HDD 68 is a storage device for storing image data, document data, software programs, font data, and various forms, for example.

The NIC (Network Interface Card) 69 is an interface device for connecting the MFP 1 to the network such as the Internet and a local area network. The USB I/F 70, IEEE 1394 I/F 71, and Centronics I/F 72 are interfaces in compliance with respective industrial standards. The operations panel 80 is an operations unit that receives user's input as well as displays various screens for the user. The FCU 81 may have battery backed-up memory, which may buffer facsimile data received while the MFP 1 is powered off.

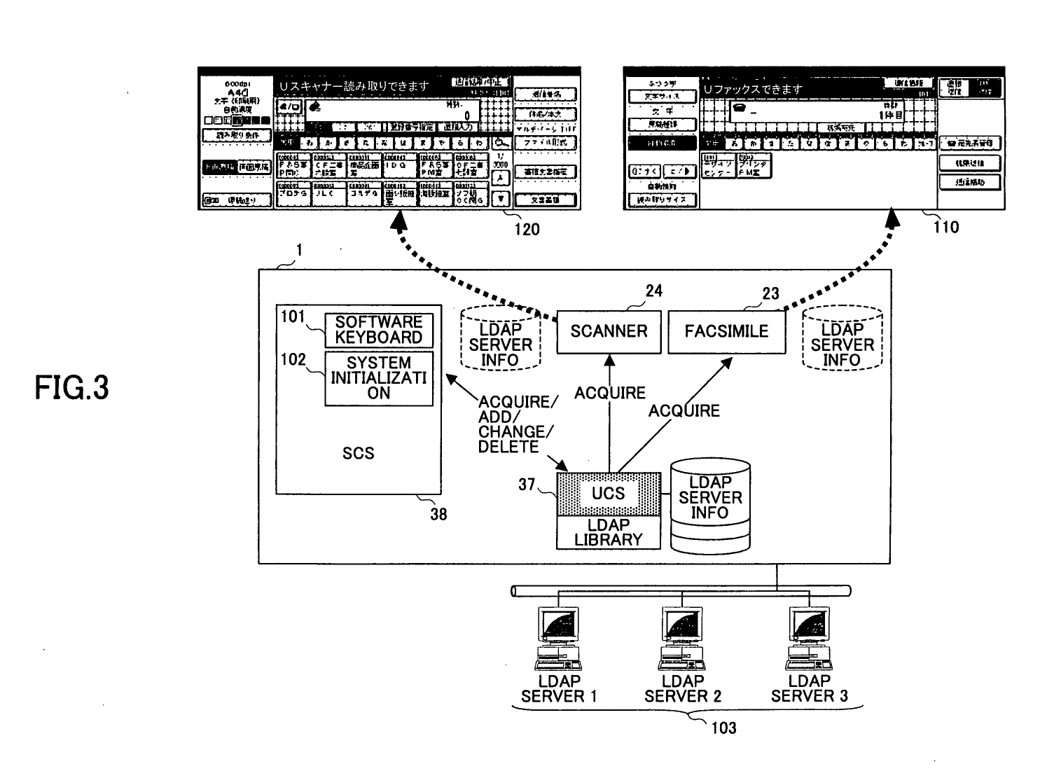

FIG. 3 is a schematic diagram for explaining requests for obtaining, adding, changing, and deleting the LDAP server information. It is noted that, in FIG. 3 and the following description, only components relevant to the present invention are shown, and other components may be omitted. The USC 37 stores the LDAP server information, for example, in a HDD 108, and centrally controls the LDAP server information.

The LDAP server information may include server name, host name (IP address), port number, the starting position of retrieval, authentication information, (multiple) retrieval condition, and character code, for example, as data items. The UCS 37 provides the LDAP server information to the facsimile application 23, the scanner application 24, and/or the SCS 38 in response to a request for the LDAP server information thereof. The UCS 37, in response to a request from the SCS 38, adds, changes, and/or deletes data items of the LDAP server information.

The facsimile application 23 can obtain the LDAP server information of the LDAP server that is to be retrieved by sending a request for the LDAP server information to the UCS 37. The facsimile application 23 obtains user information needed for the facsimile function using the LDAP server information, and displays a screen 110 in the operations panel 80 using the obtained user information. The screen indicates, for example, destination information such as facsimile numbers to which the facsimile data is to be transmitted, and a user can transmit the facsimile data to the destination by selecting the destination information.

The scanner application 24 can obtain the LDAP server information from the LDAP server 103 by sending a request for the LDAP server information to the UCS 37. Using the obtained LDAP server information, the scanner application 24 obtains user information required for the scanner function, and displays a screen 120 on the operations panel 80 using the user information. The screen 120 indicates, for example, destination information such as e-mail addresses from which the user can select the destination to which scanner data is to be transmitted via e-mail.

A system initialization function 102 of the SCS 38 can obtain, add, change, and delete the LDAP server information by sending a request for obtaining, adding, changing, or deleting the LDAP server information. The software keyboard function 101 of the SCS 38 displays and controls a software keyboard on the operations panel.

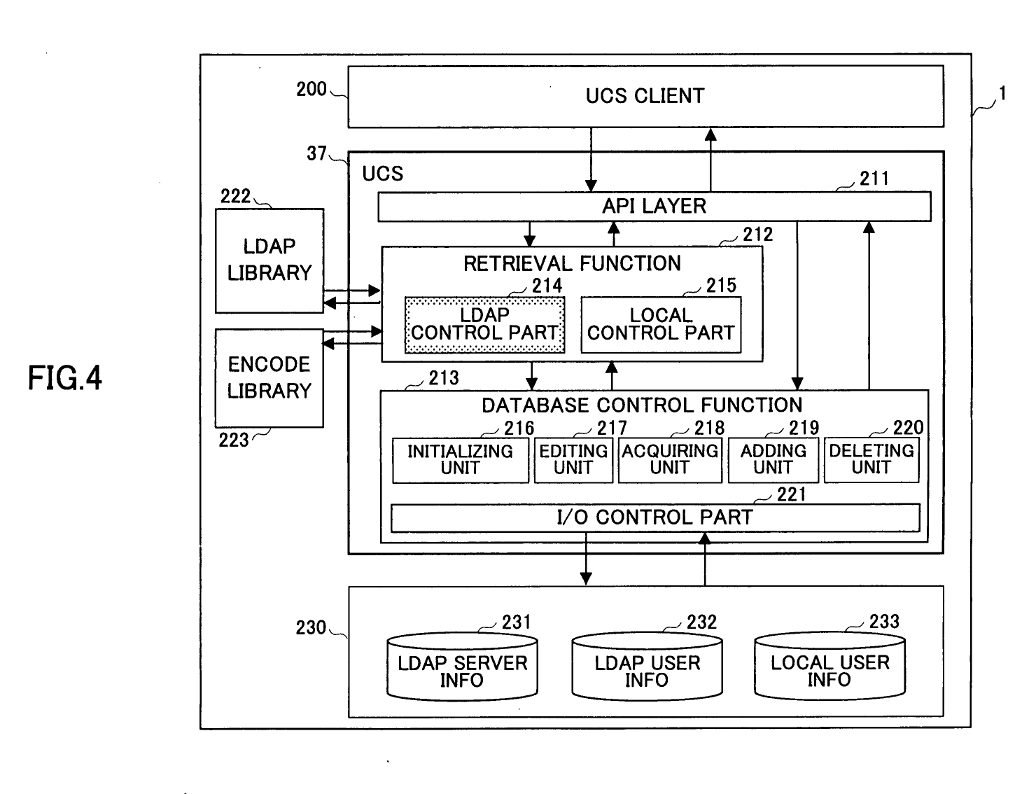

FIG. 4 is a schematic diagram for explaining the software structure of the UCS that realizes retrieving function. It is noted that only components relevant to the present invention are shown in FIG. 4, and other components may be omitted. The UCS 37 includes API layer 211, retrieval function 212, database control function 213. The PI layer 211 realizes the interface with the UCS clients 200 such as the facsimile application 23, the scanner application 24, and the SCS 38.

The retrieval function 212 is configured by a LDAP control part 214 and a local control part 215, and realizes the retrieval of data stored in the LDAP server using a LDAP library and an encode library 223. In the following description, the retrieval of data stored in the LDAP server may be referred to as “LDAP retrieval”.

The database control function 213 includes an initializing unit 216, an editing unit 217, and acquiring unit 218, an adding unit 219, a deleting unit 220, and an I/O control part 221, and controls LDAP server information 231, LDAP user information 232, and local user information 233 stored in a memory unit 230, which may be included in the HDD 68, for example.

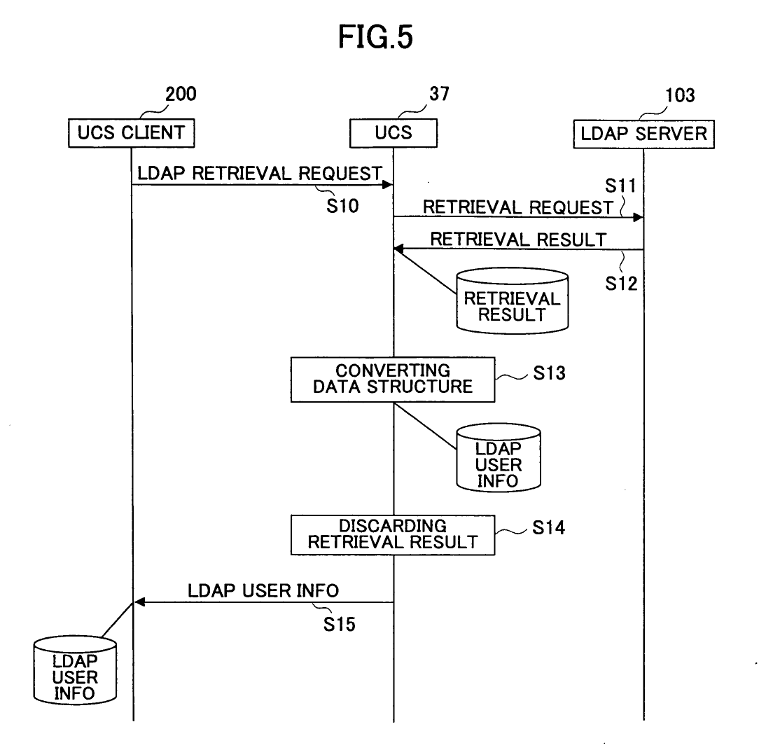

The LDAP retrieval according to an embodiment of the present invention may be performed following operational steps as shown in FIG. 5 using the MFP 1 as described above. FIG. 5 is a sequence diagram for explaining exemplary LDAP retrieval according to an embodiment of the present invention. In step S10, a UCS client 200 such as the facsimile application 23 and the scanner application 24 request the UCS 37 to retrieve the LDAP information by sending a LDAP retrieval request to the UCS 37. The UCS client 200 provides the LDAP server information to be retrieved, including the server name, the host name (IP address), and the port number, for example, and also provides retrieval information including retrieval filter, attribute to be retrieved, the starting position of retrieval, together with the LDAP retrieval request to the UCS 37.

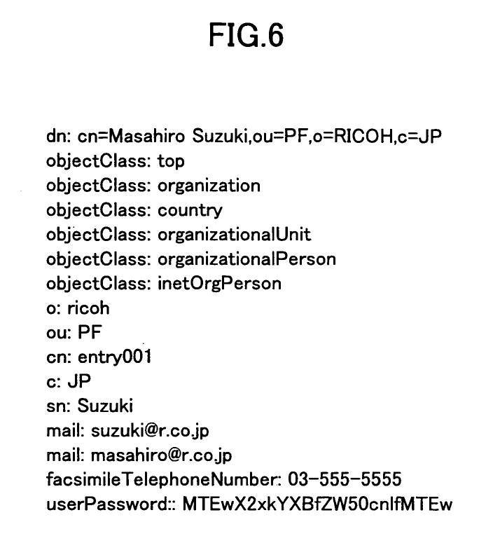

In step S11, the UCS 37 requests the LDAP server 103 identified by the LDAP server information provided by the UCS client 200 to retrieve data. In step S12, the UCS 37 receives retrieval result requested in the previous step. An exemplary retrieval result that the UCS 37 receives in step S12 is shown in FIG. 6. FIG. 6 shows the data structure of an exemplary retrieval result.

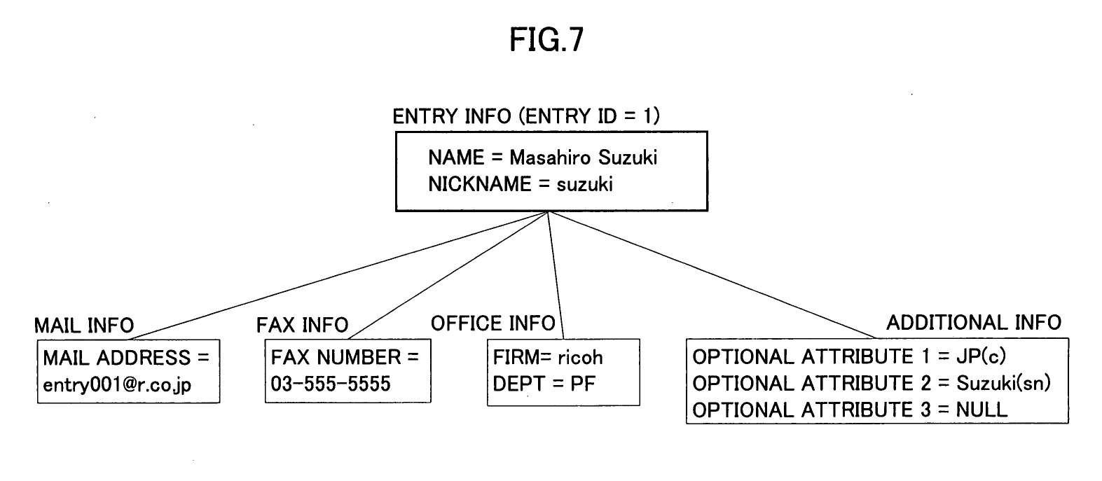

Next, in step S13, the UCS 37 converts each retrieval result as shown in FIG. 6 into LDAP user information, the data structure of which is shown in FIG. 7. FIG. 7 shows the data structure of exemplary LDAP information (LDAP user information) used in the MFP 1. As shown in FIG. 7, the LDAP user information includes entry information identified by an entry ID, and further includes mail information, facsimile information, office information, and other additional information associated thereto.

Next, in step S14, the UCS 37 discards the retrieval result shown in FIG. 6. In step S15, the UCS 37 sends the LDAP user information converted from the retrieval result in step S13 to the UCS client 200 as an response to the LDAP retrieval request received in step S10.

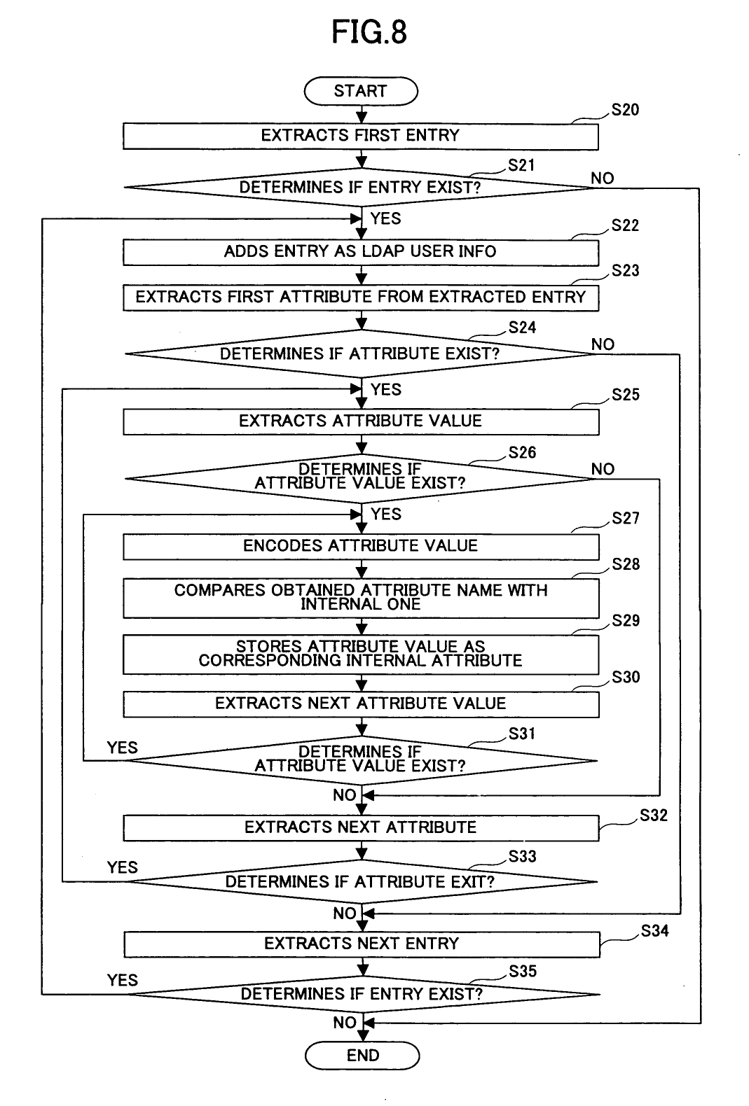

Operations in step S13 is further described in greater detail. FIG. 8 is a flowchart showing process for converting each entry of the retrieval result into LDAP user information. In step S20, the UCS 37 extracts the first entry of the retrieval result. Next, in step S21, the UCS 37 determines whether there is an entry available. If the UCS 37 determines that there is an entry available (YES in step S21), the UCS 37 adds the entry as an entry to be converted into LDAP user information in step S22. If there is no entry available (NO in step S21), the UCS 37 exits the process shown in FIG. 8.

Subsequently to step S22, in step S23, the UCS 37 extracts the first attribute of the entry extracted in step S20. For example, in the case of the retrieval result shown in FIG. 6, attribute “cn” is extracted. In step S24, the UCS 37 determines whether there is an attribute available.

If the UCS 37 determines in step S24 that there is an attribute available (YES in step S24), next step S25 is performed. The UCS 37 extracts attribute value of the extracted attribute. For example, in the case of an exemplary retrieval result shown in FIG. 6, the UCS 37 extracts attribute value “Masahiro Suzuki” of the extracted attribute “cn”. If there is no attribute available (NO in step S24), process proceeds to step S34.

Next, in step S26, the UCS 37 determines whether there is an attribute value available. If there is an attribute value available (YES in step S26), process proceeds to step S27, and the UCS 37 encodes the extracted attribute value. The encoding in step S27 allows title of the extracted attribute to be displayed on the operations panel 80 by converting character code thereof. If there is no attribute value (NO in step S26), process proceeds to step S32, which is to be described in more detail below.

Next, in step S28, the UCS 37 compares the title of the extracted attribute (hereinafter, referred to as extracted attribute title) with the title of attributes (internal attribute title) defined for internal use in MFP 1 one by one. Next, in step S29, if the UCS 37 find an internal attribute title that matches the extracted attribute title, the UCS 37 stores the attribute value of the extracted attribute as data item corresponding to the matching internal attribute title.

In step S30, the UCS 37 extracts the next attribute value. The UCS 37 determines whether there is an attribute value in step S31. If there is an attribute value (YES in step S31), process returns to step S27, and steps S27 through S31 are repeated. If there is no attribute value (NO in step S26), process proceeds to step S32.

In step S32, the UCS 37 extracts the next attribute from the extracted entry of the retrieval result in step S20. For example, in the case of the exemplary retrieval result shown in FIG. 6, the UCS 37 extracts attribute “ou”. The UCS 37 determines whether there is attribute available in step S33.

If there is an attribute available (YES in step S33), process returns to step S25. If there is no attribute available (NO in step S33), process proceeds to step S34. As a result of the above steps, the data structure of an entry has been converted into the data structure of an entry for the MFP 1.

In step S34, the UCS 37 extracts the next entry from the retrieval result. Next in step S35, the UCS 37 determines whether there is an entry available. If there is an entry available (YES in step S35), process returns to step S22. If there is no entry available (NO in step S35), the UCS 37 exits the process shown in FIG. 8.

It is currently assumed that the attribute used for the MFP 1 is text data. If the MFP 1 obtains attribute which is unexpectedly binary data such as jpeg photo, the MFP 1 may waste time by unsuccessfully encoding the binary data attribute and require longer time to return a retrieval result to the UCS client. To solve this problem, the present invention prevents the MFP 1 from obtaining attributes that are not needed and/or attributes that may require long time to be processed. It is noted however that a user can select attributes to be obtained through the operations panel 80, that is, the user may take the initiative to set the MFP 1 not to obtain attributes that are not needed and/or attributes that require long time to be processed.

### First Embodiment

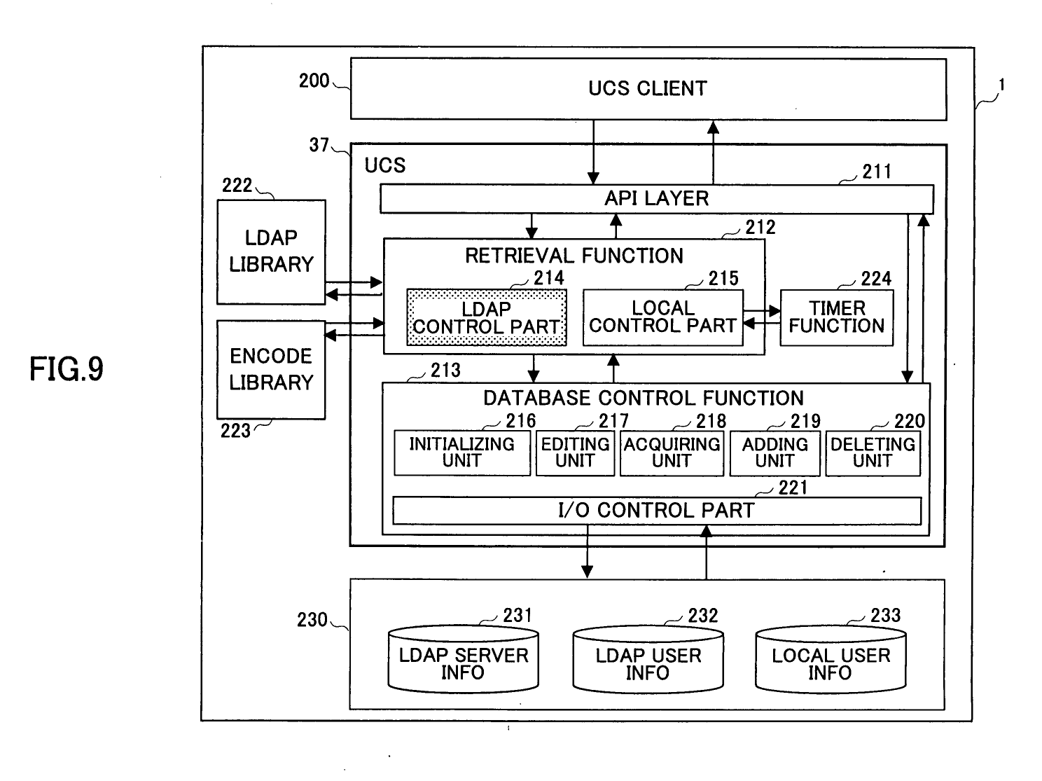

According to an first embodiment of the present invention, processing time required for each attribute in an entry is presented to the user so that the user can pick the attribute that does not need to be obtained from the next retrieval up. This embodiment prevents the user from obtaining the attribute that is picked by the user as those require long processing time. The UCS 37 may be configured as shown in FIG. 9 according to the first embodiment.

FIG. 9 is a block diagram for explaining the software structure of the UCS that realizes retrieval function according to the present invention. The block diagram shown in FIG. 9 is different from that of FIG. 4 in that timer function 224 is provided. The timer function 224 measures processing time of each attribute of the entry. All the components other than the timer function 224 are identical to those shown in FIG. 4, and therefore, their description is omitted.

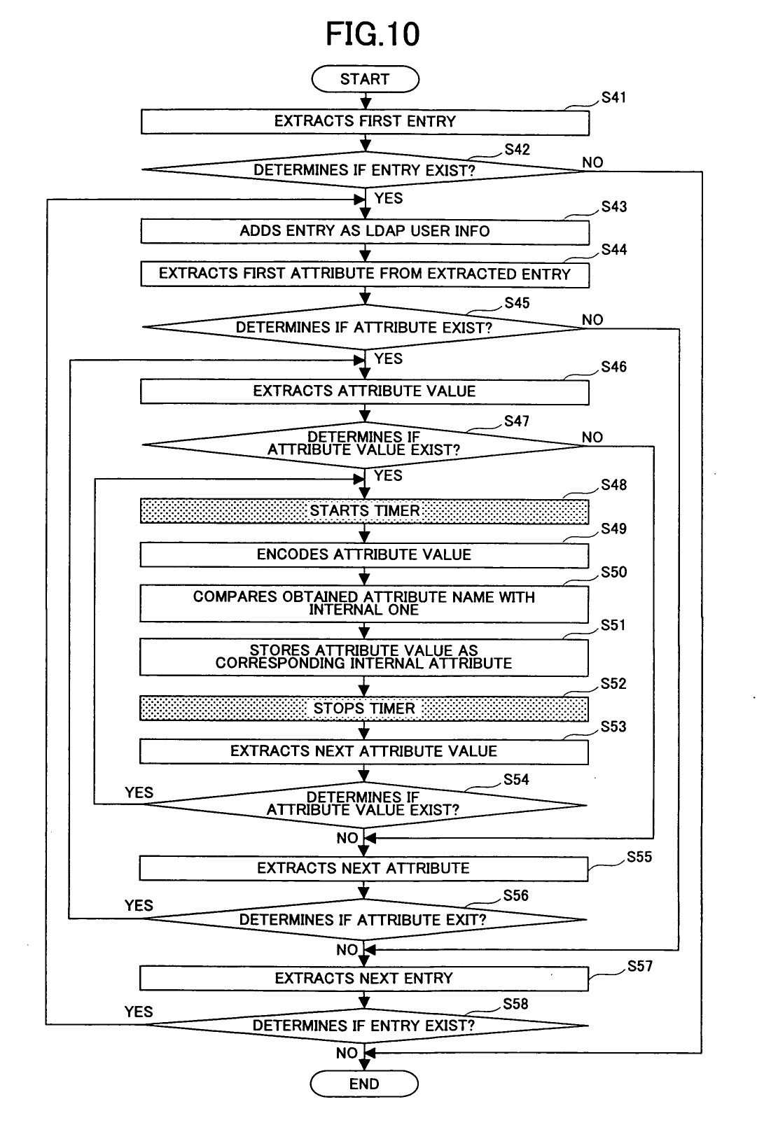

FIG. 10 is a flowchart showing an exemplary process in which processing time is measured for each attribute of the retrieval result, the data structure of which is converted into that of the MFP 1. The flowchart shown in FIG. 10 is different from the flowchart shown in FIG. 8 in that the step of starting timer (step S48) and the step of stopping timer (step S52) are additionally inserted.

Steps S41 through S47 shown in FIG. 10 are identical to steps S20 through S26 shown in FIG. 8, and therefore, their description is omitted. If there is an attribute value available (YES in step S47), process proceeds to step S48, and the timer of the timer function 224 is started. Next, in step S49, the UCS 37 encodes the extracted attribute value. In step S50, the UCS 37 compares the extracted attribute title and the internal attribute title one by one. Process proceeds to step S51, if the UCS 37 finds an internal attribute title that matches the extracted attribute title, the UCS 37 stores the extracted attribute value as an data time corresponding to the matching internal attribute title.

Next, in step S52, the UCS 37 stops the timer of the timer function 224. In steps S49 through S51, an attribute of the entry is stored as the LDAP user information of the MFP 1 and made available for the UCS client 200. As a result, by starting the timer in step S48 and stopping it in step S52, processing time in which an attribute of an entry is stored as LDAP user information of the MFP 1 and made available for the UCS client 200 can be measured. The measured processing time is stored in the LDAP server information 231 as processing time information.

Additionally, by summing processing times of all attributes of an entry, total processing time in which the one entry is stored as LDAP user information, and made available for the UCS client 200 can be obtained. Steps S53 through S58 are identical to steps S30 through S35 shown in FIG. 8, and therefore, their description is omitted.

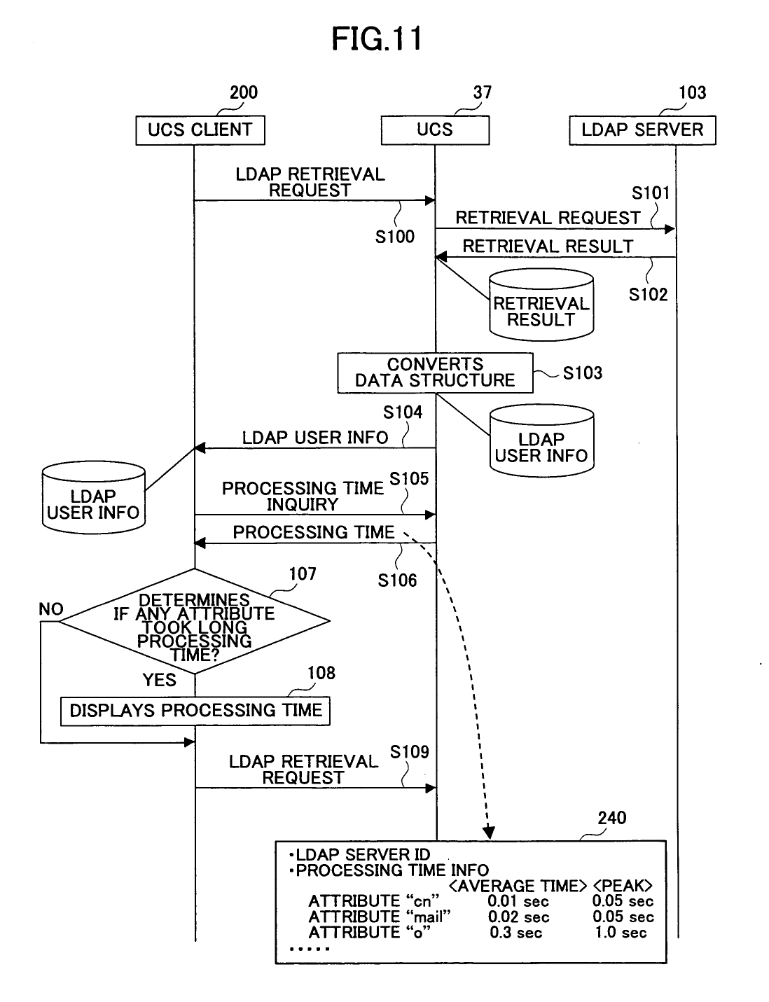

FIG. 11 is a sequence diagram showing exemplary LDAP retrieval according to the first embodiment of the present invention. After all attributes are processed, processing time required for processing each attribute is presented thereby to enable the user to pick any attributes that do not need to be obtained from the next retrieval up.

In step S100, the UCS client 200 requests the UCS 37 for LDAP retrieval. The UCS client 200 provides LDAP server information such as server name, host name (IP address), and port number of the LDAP server to be accessed, and retrieval information such as retrieval filter, attributes to be obtained, and starting point of retrieval to the UCS 37 upon requesting for LDAP retrieval. In the following description, an assumption is made that attributes “cn”, “mail”, and “o” are included in an entry.

Next, in step S101, the UCS 37 requests the LDAP server 103 identified by the LDAP server information from the UCS client 200 to perform LDAP retrieval in accordance with the retrieval information. In step S102, the UCS 37 receives the retrieval result which is a response from the LDAP server 103 to the LDAP retrieval request made in step

Next, in step S103, the UCS 37 converts the entry of the retrieval result into the LDAP user information by changing the data structure of the entry in accordance with the procedure shown in FIG. 10. In step S103, processing time is measured in which each attribute of the entry is processed, and is stored in the LDAP server information 231 as processing time information. The UCS 37 discards the retrieval result after completing step S103.

In step S104, the UCS 37 provides the LDAP user information converted from the retrieval result in step S103 to the UCS client 200 as an response to the LDAP retrieval request made in step S100. The UCS client 200 inquires the processing time to the UCS 37 in step S105. Process proceeds to step S106, in which the UCS 37 reads the processing time information 240 from the LDAP server information 231, and provides the processing time information 240 to the UCS client 200.

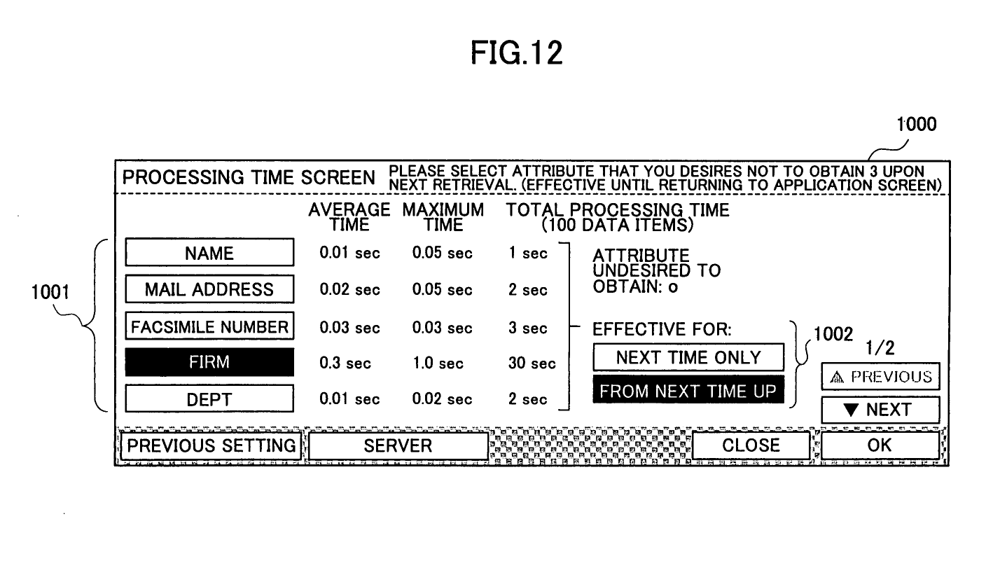

The processing time information 240 is separately managed for each LDAP server 103, and includes LDAP server ID for identifying the LDAP server, average and peak processing time for each attribute. Next, in step S107, the UCS client 200 determines whether any attribute has required processing time longer than predetermined threshold value. If there is an attribute that took processing time longer than the predetermined threshold value, the UCS client displays processing time screen 1000 as shown in FIG. 12 on the operations panel 80.

FIG. 12 shows an exemplary processing time screen according to an embodiment of the present invention. The processing time screen 1000 includes attributes, average, maximum, and total (100 data items, for example) processing time for each attribute, one or more attributes that is not to be obtained, and effective period in which the designation of the one or more attributes that is not to be obtained is effective.

The user can select the one or more attributes that is not to be obtained by pressing attribute button 1001 in the processing time screen 1000 and highlighting the one or more attributes that is not to be obtained as shown in FIG. 12. In the exemplary processing time screen shown in FIG. 12, the attribute “firm”, the processing time of which is relatively longer than those of the other attributes, is selected as not to be obtained. The effective period in which the selected attribute as not to be obtained can be set using effective period buttons 1002 provided in the processing time screen 1000.

If “next time only” is selected as the effective period, the setting of the attributes as not to be obtained is effective until the next LDAP retrieval screen is turned off. If “from next time up” is selected as the effective period, the setting of the attributes as not to be obtained is effective from the next retrieval up. According to another embodiment, the effective period may be fixed to either “next time only” or “from next time up”. According to yet another embodiment, the effective period in which the setting of the attributes as not to be obtained is effective may be once set as “from next time up”, but reset as “next time only”. The effective period in which the setting of the attributes as not to be obtained is effective may be stored, for example, in the UCS client 200 for each LDAP server 103.

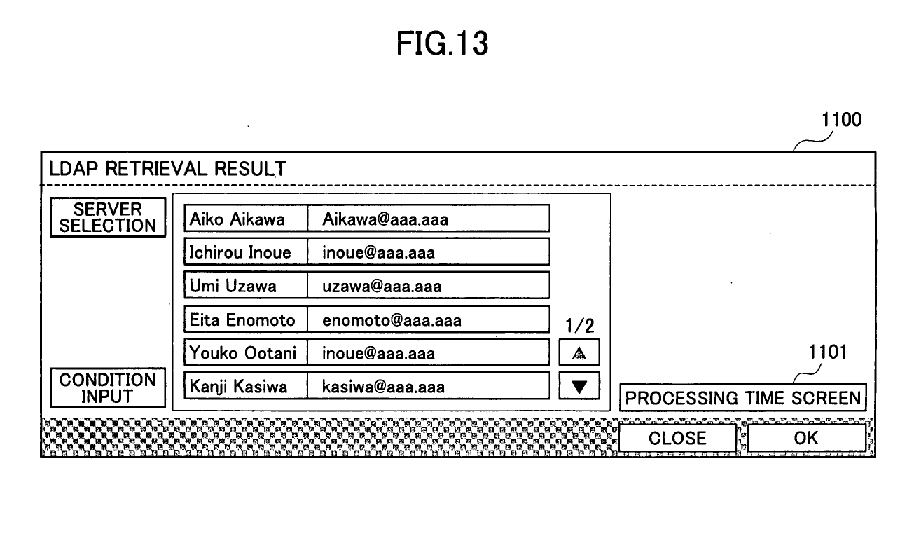

The UCS client 200 displays LDAP retrieval result screen 1100 as shown in FIG. 13 on the operations panel 80 before step S107 or after step S108 for the user's confirmation. FIG. 13 is an exemplary LDAP retrieval result screen according to an embodiment.

Subsequently, process proceeds to step S109, in which the UCS client 200 makes the next LDAP retrieval request to the UCS 37. Assuming that the attribute “o” is selected as not to be obtained in step S108, the attribute “o” is removed from the attributes to be obtained indicated in the retrieval information provided to the UCS 37 together with the LDAP retrieval request. As a result, the attributes “cn” and “mail” remains to be obtained.

According to the embodiment shown in the sequence diagram of FIG. 11, a determination is made of whether any attribute takes longer processing time than the predetermined threshold value. If there is an attribute that takes longer processing time than the predetermined threshold value, the processing time screen 1000 is displayed as shown in FIG. 12. According to another embodiment, however, a determination whether any attribute takes longer processing time than the predetermined threshold value may not need to be made by the UCS client 200.

For example, instead of step S107, process may display the LDAP retrieval result screen 1100 shown in FIG. 13 on the operations panel 80, and then proceeds to step S108 when a processing time screen button 1101 is pressed.

The first embodiment of the present invention allows the user to check processing time of each attribute of an entry and exclude any attribute that takes longer processing time than the predetermined threshold value at the user's discretion.

### Second Embodiment

According to a second embodiment, if there is any attribute that takes longer processing time than a reference time, the attribute and the processing time that the attribute consumes are presented to the user, and the user can designate the attribute so that the designated attribute is not obtained in the future LDAP retrieval. The user can designate any attribute that takes long processing time as attributes that are not obtained. The software configuration of the UCS 37 according to the present embodiment is identical to the configuration shown in FIG. 9.

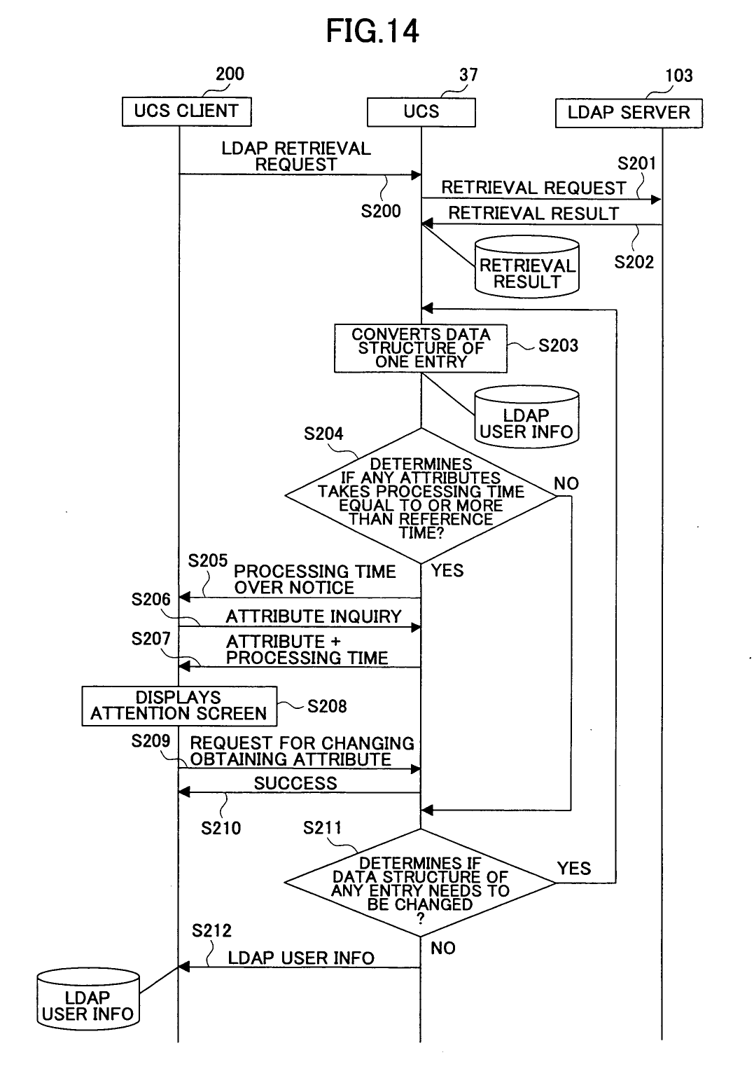

FIG. 14 is a sequence diagram showing exemplary LDAP retrieval according to the second embodiment of the present invention. As shown in the sequence diagram of FIG. 14, if there is any attribute that requires processing time longer than the reference time, process displays the attribute and corresponding processing time for the user, and allows the user to set the attribute not to be obtained in the future LDAP retrieval.

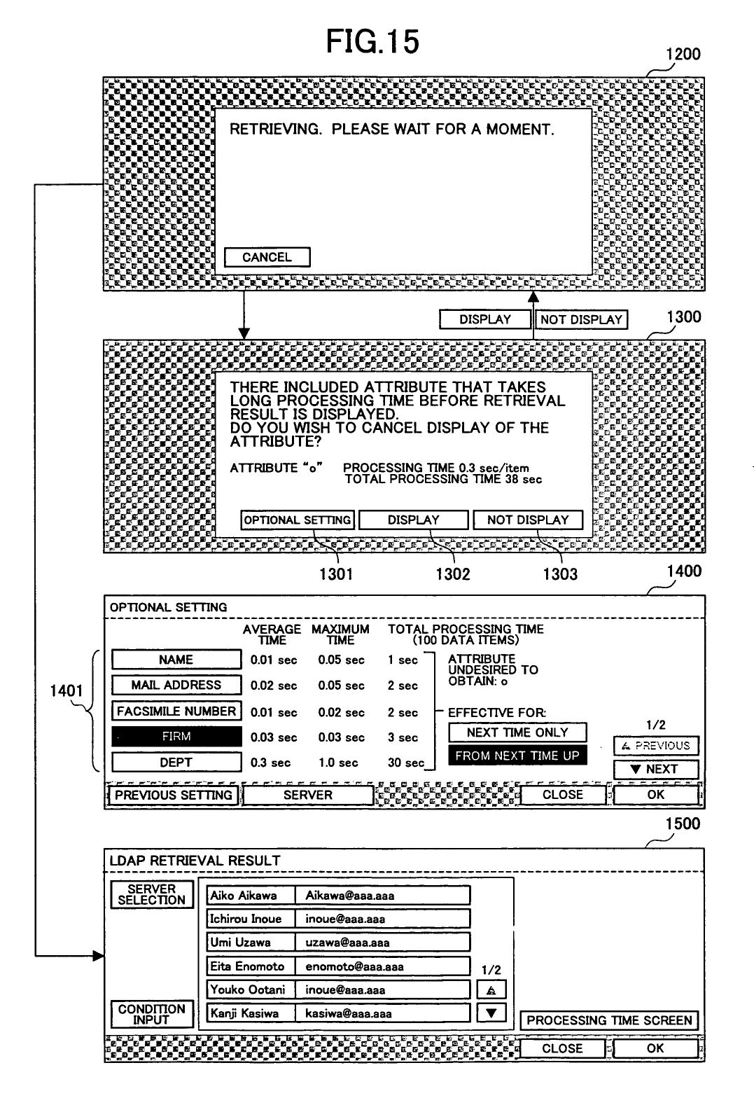

In step S200, the UCS client sends a LDAP retrieval request to the UCS 37. The UCS client 200 may provide the LDAP server information indicating server name, host name (IP address), and port number of the LDAP server that is to be retrieved, and the retrieval information such as retrieval filter, attribute to be obtained, starting position of retrieval, and the reference time to the UCS 37 together with the LDAP retrieval request. Subsequently to step S200, the UCS client 200 displays a screen 1200 as shown in FIG. 15 on the operations panel 80. FIG. 15 shows the transition of exemplary screens according to the present embodiment.

In step S201, the UCS 37 sends a retrieval request in accordance with the provided retrieval information to the LDAP server 103 identified by the provided LDAP server information. In step S202, the UCS 37 receives retrieval result from the LDAP server 103 in response to the retrieval request sent in step S101.

Next, in step S203, following the exemplary procedure shown in the flowchart of FIG. 10, the UCS 37 converts the data structure of an entry contained in the retrieval result into that of LDAP user information that can be handled by the MFP 1. In step S203, processing time that each attribute of the entry requires is measured, and stored in the LDAP server information 231 as processing time information. The UCS 37 discards the retrieval result after step S203.

Next, in step S204, the UCS 37 reads the processing time information from the LDAP server information 231, and determines whether there is any attribute that requires processing time longer than a reference time. The reference time is the one that is provided from the UCS client 200.

If there is the processing time of any attribute exceeds the reference time (YES in step S204), process proceeds to step S205 in which the UCS 37 informs the UCS client 200 of the exceeding of the processing time (sends a processing time over notice). If no attribute requires processing time longer than the reference time (NO in step S204), the UCS 37 proceeds to step S211.

In step S206, the UCS client 200 inquires the UCS 37 of the attribute that requires longer processing time than the reference. In response to the inquiry, the UCS 37 informs the UCS client 200 of the attribute that requires longer processing time than the reference, and their actual processing time in step S207.

The UCS client 200 displays a screen 1300 as shown in FIG. 15 on the operations panel 80 in step S208. The screen 1300 includes the attributes that requires processing time longer than the reference time, their individual processing time, and total processing time.

The user can select the attribute that requires longer processing time than the reference time by pressing a “not display” button 1303 so that the attribute is not obtained in the LDAP retrieval. If the user still desires to obtain the attribute that requires longer processing time than the reference time, the user can obtain the attribute by pressing a “display” button 1302 in the screen 1300. If a “optional setting” button 1301 in the screen 1300 is pressed, the UCS client 200 displays an optional setting screen 1400 on the operations panel 80.

The optional setting screen 1400 includes attributes, average and maximum processing time of each attribute, total processing time required for a certain number of retrieval (100 retrievals for example), the total processing time of all attributes to be obtained, any attribute that is not to be obtained, and effective period in which the setting is effective. The user may select the attribute that is not to be obtained by pressing and highlighting corresponding attribute button 1401. The effective period in which the setting is effective shown in the optional setting screen 1400 is similar to that of the processing time screen 1000 shown in FIG. 12.

The attributes may be sorted in the optional setting screen 1400 based on the processing time. The total processing time shown in the optional setting screen 1400 may change as the selection of attributes selected as those that are not to be obtained is changed.

When the “not display” button 1303 is pressed in the screen 1300, process proceeds to step S209 in which the UCS client 200 sends a request for changing obtaining attribute to the UCS 37 to select the attribute that is not to be obtained. If any attribute is designated as that not to be obtained in the optional setting screen 1400, the UCS client 200 sends a request for changing obtaining attribute to the UCS 37 in step S209.

Next, in step S210, when the setting of obtaining attribute is successfully set in response to the request sent in step S209, the UCS 37 notifies the UCS client 200 of the success. In step S211, the UCS 37 determines whether there is an entry that is to be converted into the data structure of an entry of the MFP 1 in the retrieval result. If the UCS 37 determines that there is an entry that is to be converted into the data structure of an entry of the MFP 1 (YES in step S211), the UCS 37 returns to step S203. If the UCS 37 determines that there is no entry that is to be converted into the data structure of an entry of the MFP 1 (NO in step S211), the UCS 37 provides the LDAP user information converted from the retrieval result in step S203 to the UCS client 200 as a response to the LDAP retrieval result in step S200. Then, the UCS client 200 display a LDAP retrieval result screen as shown in FIG. 15 on the operations panel 80 so that the user can check the LDAP retrieval result.

The present embodiment allows the user to check the attribute that requires processing time longer than the reference time, if any, and set the attribute as the one that is not to be obtained at the user's discretion.

### Third Embodiment

According to a third embodiment of the present invention, processing time of each LDAP server 103 is stored separately and, if the stored processing time exceeds a reference time, it is presented with the attribute to the user so that a determination can be made of whether the attribute that requires processing time longer than the reference time is to be obtained when the the LDAP server information is set.

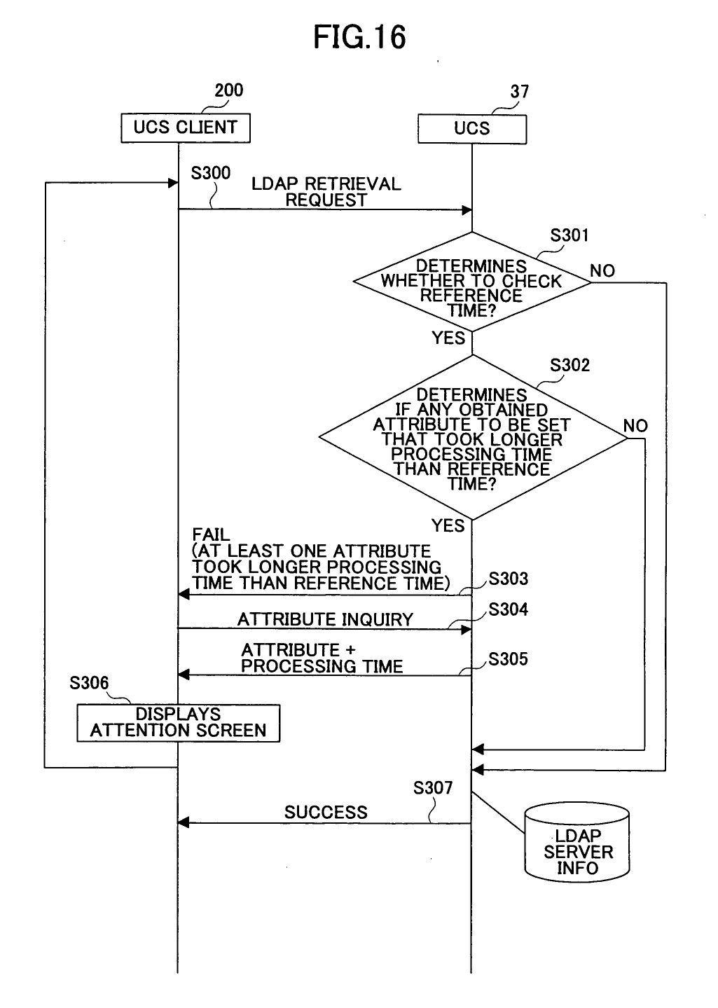

FIG. 16 is a sequence diagram showing the setting of the LDAP server information according to an embodiment of the present invention. When the LDAP server information is set, the attribute that requires processing time longer than the reference time and its processing time are presented to the user.

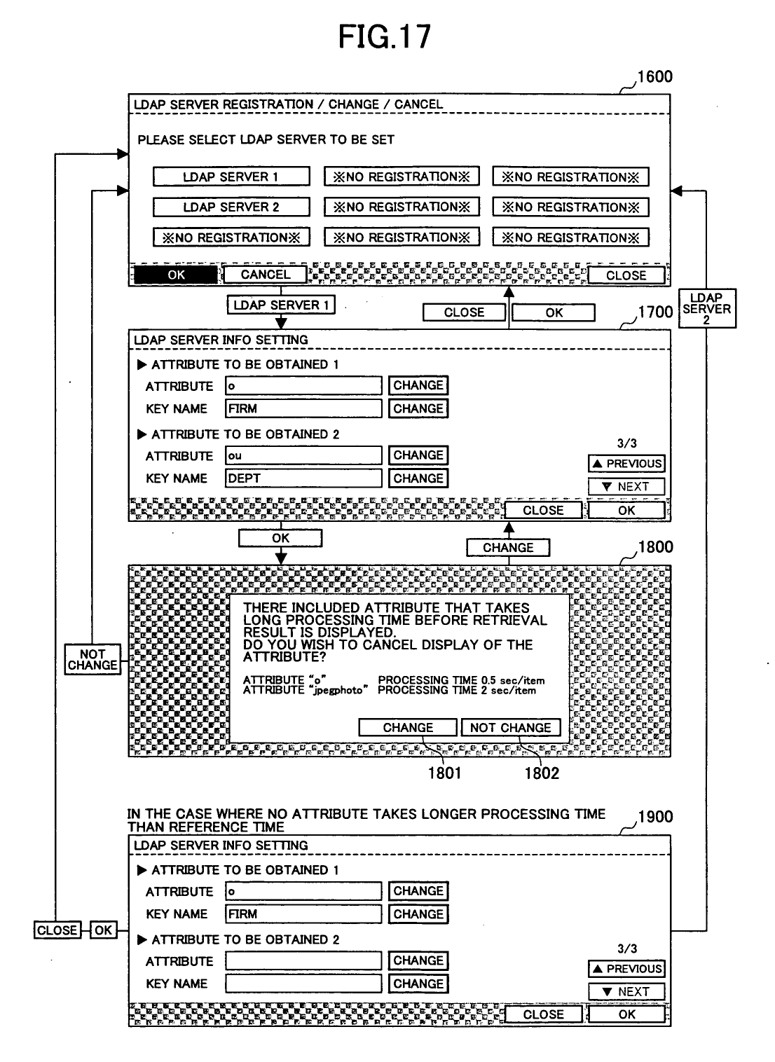

A LDAP server registration/change/cancel screen 1600 as shown in FIG. 17 is displayed on the operations panel 80 of the MFP 1. FIG. 17 shows the transition of exemplary screens according to the third embodiment. The LDAP server 103 is selected and set through the LDAP server registration/change/cancel screen 1600 by the user. If a LDAP server 103 that has not been registered is selected, “no registration” button is pressed first.

When a LDAP server 103 is selected, a LDAP server information setting screen 1700 is displayed on the operations panel 80. The attribute to be obtained (obtaining attribute) is set in the LDAP server information setting screen 1700 by the user. When the attribute is set in the LDAP server information setting screen 1700, the UCS client 200 proceeds to step S300 in which the UCS client 200 sends the UCS 37 a request for setting the LDAP server information. When requesting the UCS 37 for setting the LDAP server information, the UCS client provides the LDAP server information such as the server name, the host name (IP address), and/or the port number, and the retrieval information such as the retrieval filter, the attribute to be obtained, the starting point for retrieval, the reference time, and/or whether to check the reference time to the UCS 37 as well as the LDAP server information setting request.

Next, in step S301, the UCS 37 determines whether, according to the retrieval condition received with the LDAP server information setting request, comparison of the processing time with the reference time is required. If the UCS 37 determines that the comparison of the processing time with the reference time is to be made (YES in step S302), the UCS 37 proceeds to step S302, and otherwise (NO in step S302) to step S307.

In step S302, the UCS 37 determines whether there is any attribute that has required processing time longer than the reference time among the attributes that are going to be set. If a determination is made that any attribute has required processing time longer than the reference time (YES in step S302), process proceeds to step S303 in which the UCS 37 sends a “fail” message to the UCS client 200 indicating that there is one or more attributes that have required processing time longer than the reference time among the attributes that are going to be set. If a determination is made that there is no attribute included that has required processing time longer than the reference time (NO in step S302), the UCS 37 proceeds to step S307.

In step S304, the UCS client 200 sends an inquiry to the UCS 37 which attribute has required processing time longer than the reference time. Next, in step S305, the UCS 37 informs the UCS client 200 of the attribute that has required processing time longer than the reference time as well as the processing time.

In step S306, the UCS client 200 displays a screen 1800 as shown in FIG. 17 on the operations panel 80 in order to draw the user's attention. The screen 1800 includes the attribute that has required processing time longer than the reference time as well as the processing time.

The user can leave the attribute that has required processing time longer than the reference time as the one that is not to be obtained by pressing a “not change” button 1802 in the screen 1800. If the user presses a “change” button 1801 in the screen 1800, the user can designate the attribute that has required processing time longer than the reference time as the one to be obtained. When the “not change” button 1802 is pressed, the UCS client 200 displays the LDAP server registration/change/cancel screen 1600 on the operations panel 80 again.

In step S307, the UCS 37 sends a “success” message to the UCS client 200, the success message indicating that there is no attribute that has required processing time longer than the reference time included in the attribute to be set. In response to the receipt of the success message, that is, if there is no attribute that has required processing time longer than the reference time among the attributes that are to be obtained, the UCS client 200 displays the LDAP registration/change/cancel screen 1600 on the operations panel 80 but does not display the screen 1800 for drawing the user's attention as shown in FIG. 17.

The user can check whether there is any attribute that has required processing time longer than the reference time before obtaining the attribute.

### Fourth Embodiment

According to a fourth embodiment of the present invention, the processing time that the attribute requires is stored for each LDAP server 103, and the attribute that requires processing time longer than the reference time as well as the processing time is presented to the user. The software structure of the UCS 37 is identical to that shown in FIG. 9.

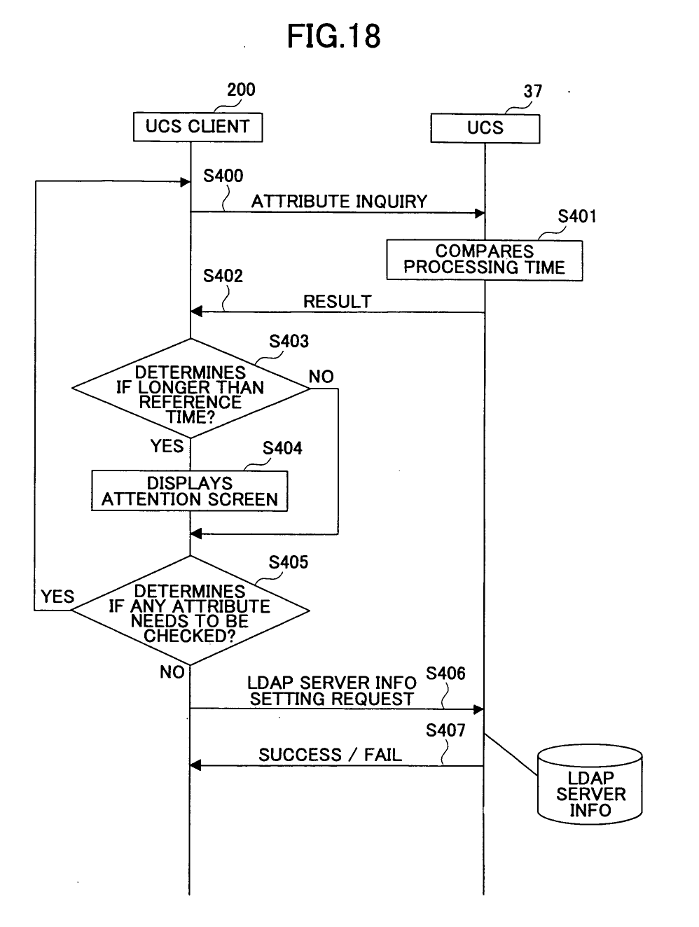

FIG. 18 is a sequence diagram showing the setting of attribute according to an embodiment of the present invention. As shown in the sequence diagram, when the attributes are set, the attribute that requires processing time longer than the reference time, and the processing time of the attribute is presented to the user so that the user can check whether the attribute is to be obtained or not.

First, the user causes the MFP 1 to display the LDAP server information setting screen 1700 as shown in FIG. 17 on the operations panel 80 of the MFP 1. The user sets the attributes to be obtained through the LDAP server information setting screen 1700. When the attributes are set through the LDAP server information setting screen 1700, the UCS client 200 sends an attribute inquiry as well as LDAP server ID, attribute name, and the reference time to the UCS 37.

In step S401, the UCS 37 compares the processing time information with the reference time provided from the UCS client 200. The UCS 37 sends the result of the comparison in step S401 to the UCS client 200. The comparison result includes information such as whether the processing time is longer than the reference time, whether the processing time is equal to or shorter than the reference time, average processing time, and maximum processing time.

Next, in step S403, the UCS client 200 determines whether there is any attribute that has required processing time longer than the reference time among the attributes to be set. If the UCS client 200 determines that there is one or more attributes that has required processing time longer than the reference time (YES in step S403), the UCS client 200 displays the screen 1700 for drawing the user's attention as shown in FIG. 17 on the operations panel 80.

If the user presses the “not change” button 1802 in the screen 1800, the attribute that has required processing time longer than the reference time is not set as the one that is to be obtained. If the user presses the “change” button 1801, the attribute is set as the one that is to be obtained even if the attribute has required processing time longer than the reference time. When either the “change” button 1801 or the “not change” button 1802 in the screen 1800 is pressed, the UCS client 200 proceeds to step S405. If the UCS client 200 determines that there is no attribute that has required processing time longer than the reference time (YES in step S403), the UCS client 200 proceeds to step S405.

In step S405, the UCS client 200 determines whether there is any attribute that needs to be inquired to the UCS 37. If the UCS client 200 determines that there is one or more attributes that need to be inquired to the UCS 37 (YES in step S405), the UCS client returns to step S400. If the UCS client 200 determines that there is no attribute that need to be inquire to the UCS 37 (NO in step S405), process proceeds to step S406 in which the UCS client 200 sends a LDAP server information setting request to the UCS 37. Next, in step S407, the UCS 37 informs whether the LDAP server information setting request has been successfully processed or not to the UCS client 200.

The present embodiment allows the user to check the attribute that has required processing time longer than the reference time before setting the attribute as the one to be obtained.

### Fifth Embodiment

According to a fifth embodiment of the present invention, a pre-retrieval is performed for determining whether there is any attribute that requires processing time longer than the reference time, and if any, the attribute and its processing time are presented to the user when the LDAP server information is set. The software structure of the UCS 37 is identical to that of FIG. 9.

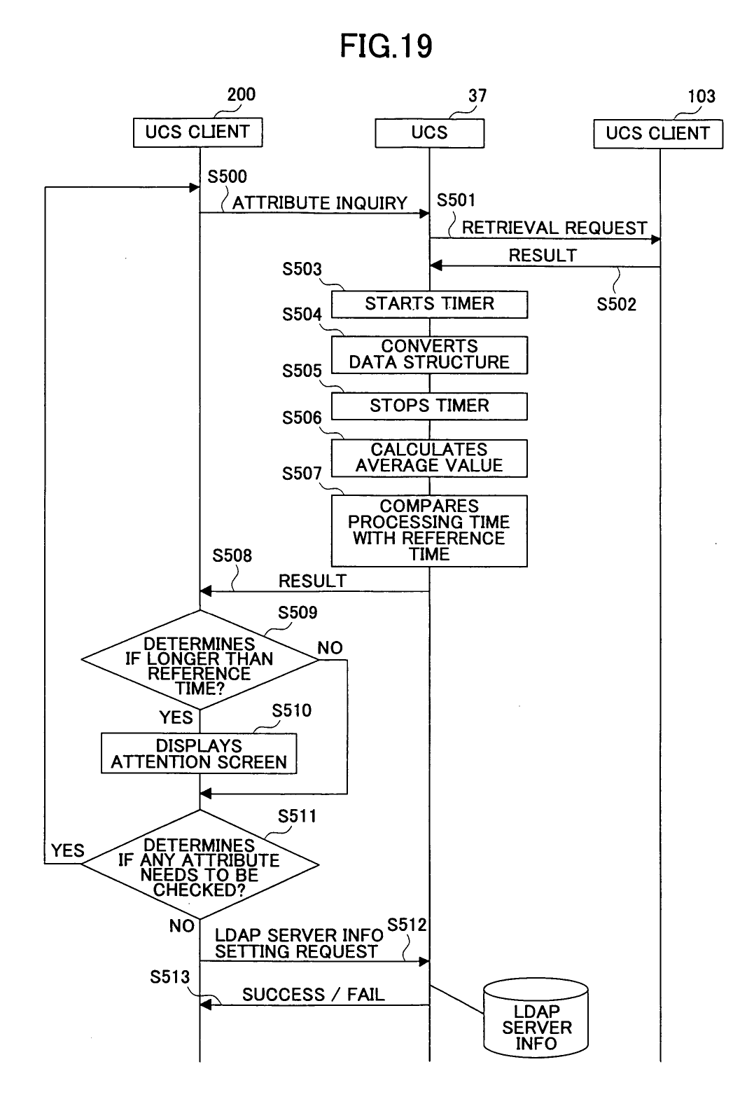

FIG. 19 is a sequence diagram showing the setting of LDAP server information according to an embodiment of the present invention. As shown in the sequence diagram of FIG. 19, the pre-retrieval is performed prior to the setting of the LDAP server information. If there is any attribute that requires processing time longer than the reference time, the attribute and its processing time are presented to the user for confirmation.

The user causes the MFP 1 to display the LDAP server information setting screen 1700 shown in FIG. 17 on the operations panel 80. The user can set the attributes that are to be obtained through the LDAP server information setting screen 1700. When the attribute is set through the LDAP server information setting screen 1700, the UCS client 200 proceeds to step S500, and sends an attribute inquiry as well as the LDAP server information such as the server name, the host name (IP address), and the port number, and the retrieval information such as the retrieval filter, the attributes to be obtained, the starting point of retrieval, the reference time to the UCS 37.

Next, in step S501, the UCS 37 sends a retrieval request based on the attribute inquiry to the LDAP server 103 identified by the LDAP server information in which the LDAP retrieval is performed provided by the UCS client 200. Process proceeds to step S502, the UCS 37 receives the retrieval result in response to the retrieval request in step S501.

Next, in step S503, the timer function 224 starts a timer. Following the procedure shown in the flowchart of FIG. 10, for example, the UCS 37 converts the retrieval result into the data structure of the entry for the MFP 1, thereby to form the LDAP user information. In step S505, the UCS 37 causes the timer function 224 to stop the timer.

The UCS 37 calculates the average of processing time for each attribute designated in the retrieval request based on the attribute inquiry in step S506. In step S507, the UCS 37 compares the calculated average of the processing time of each attribute with the reference time. Process proceeds to step S508, the UCS 37 sends the result of comparison in step S507 to the UCS client 200. Since steps S509 through S513 are identical to steps S403 through S407 shown in FIG. 18, their description is omitted.

The fifth embodiment of the present invention allows the user to perform pre-retrieval of the attributes to be obtained before the setting of the LDAP server information thereby to check the attribute that requires processing time longer than the reference time.

### Sixth Embodiment

In the above embodiments, it is the processing time that is presented to the user for the user's setting of the attributes to be obtained. However, instead of the processing time, data size associated with the attributes may be presented to the user for the user's setting of the attributes to be obtained. According to a sixth embodiment, data size is used instead of the processing time.

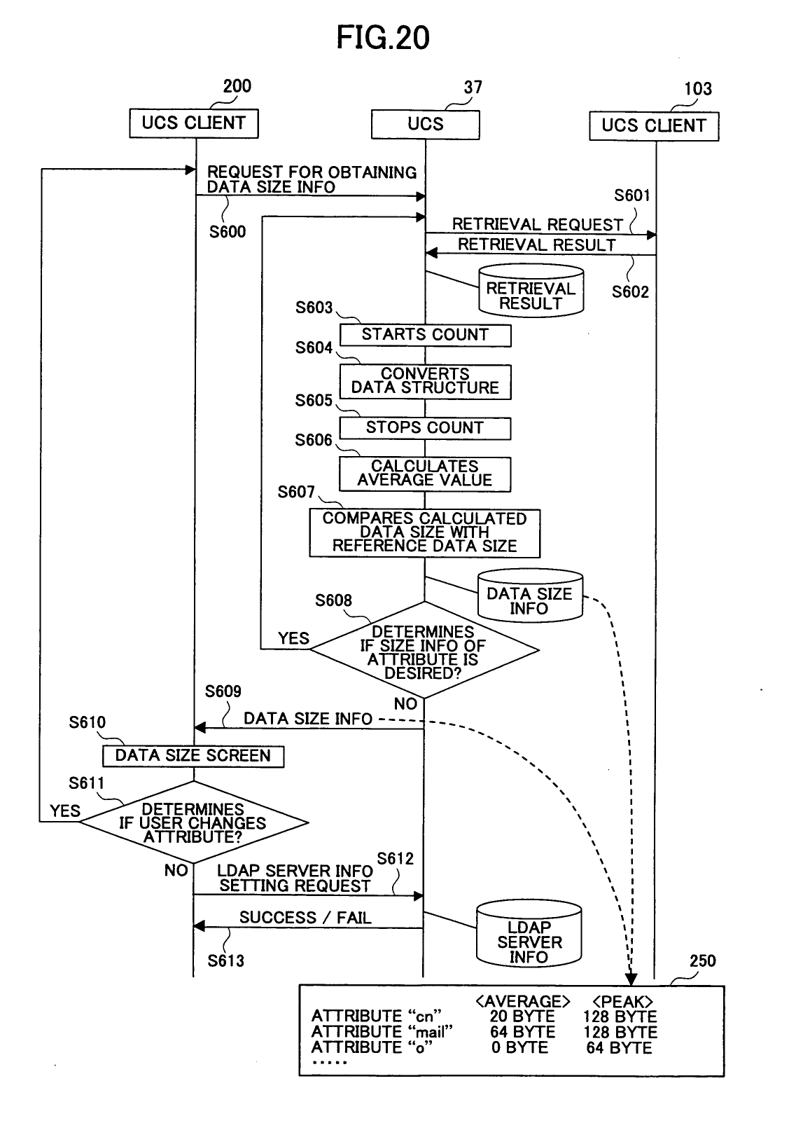

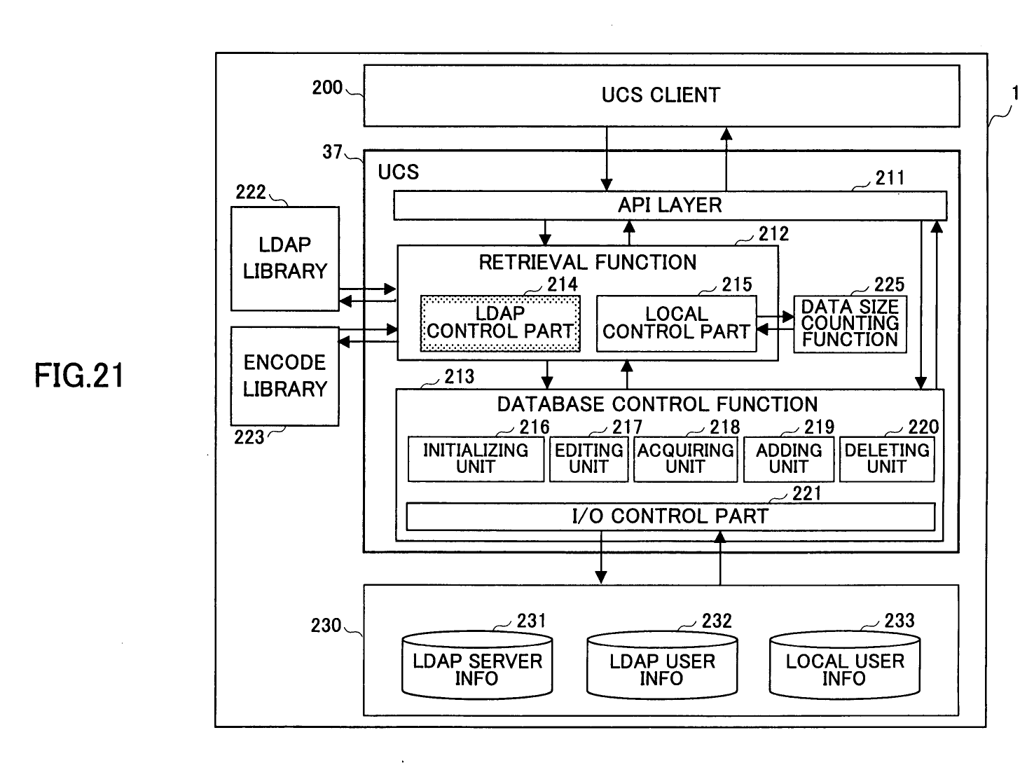

FIG. 20 is a sequence diagram showing an exemplary process to set the LDAP server information according to the sixth embodiment of the present invention. As shown in the sequence diagram, pre-retrieval is performed thereby to present the attribute, the data size of which is larger than a predetermined reference data size. The user is allowed to check the presented attribute and its data size before setting the attribute as the one to be obtained. The UCS 37 that realizes the sixth embodiment may be configured as shown in FIG. 21.

FIG. 21 is a block diagram for explaining the software structure of the UCS for realizing retrieval function according to the present embodiment. The UCS 37 shown in FIG. 21 is different from the UCS 37 shown in FIG. 4 in that data size counting function 225 is additionally provided. The data size counting function 225 counts data size associated with each attribute of an entry. Since components other than the data size counting function 225 shown in FIG. 21 are identical to those of FIG. 4, their description is omitted.

The user causes the MFP 1 to display the LDAP server information setting screen 1700 on the operations panel 80. The user sets the attributes to be obtained in the LDAP server information setting screen 1700. When the attribute to be obtained is set, the UCS client 200 proceeds to step S600 in which the UCS client 200 sends a request for obtaining data size information as well as the LDAP server information such as the saver name, the host name (IP address), the port number, and SSL setting of the LDAP server to be retrieved, and the retrieval information such as the retrieval filter, the attributes to be obtained, the starting position of retrieval, and the reference data size to the UCS 37.

Next, in step S601, the UCS 37 sends a retrieval request based on the request for obtaining data size information in step S600 to the LDAP server 103 identified by the LDAP server information provided from the UCS client 200. The retrieval request may include a maximum entry number, the attributes to be obtained, retrieval filter, and timeout, for example, as retrieval conditions. Process proceeds to step S602 in which the UCS 37 receives retrieval result from the LDAP server in response to the retrieval request in step S601.

In step S603, the data size counting function 225 starts counting data size associated with each attribute. In step S604, the UCS 37 follows the procedure as shown in FIG. 10, for example, thereby to convert the data structure of an entry for the MFP 1 into that of the LDAP user information. In step S605, the UCS 37 starts counting the data size.

Next, in step S606, the UCS 37 calculates the average data size of each attribute included in the retrieval request sent in step S601 based on the request for obtaining data size information. Process proceeds to step S607 in which the UCS 37 the calculated data size and the reference data size. In step S608, the UCS 37 determines whether it requires data size information associated with the attributes to be obtained. If the UCS 37 determines that it requires additional data size information associated with the attribute (YES in step S608), the UCS 37 returns to step S601.

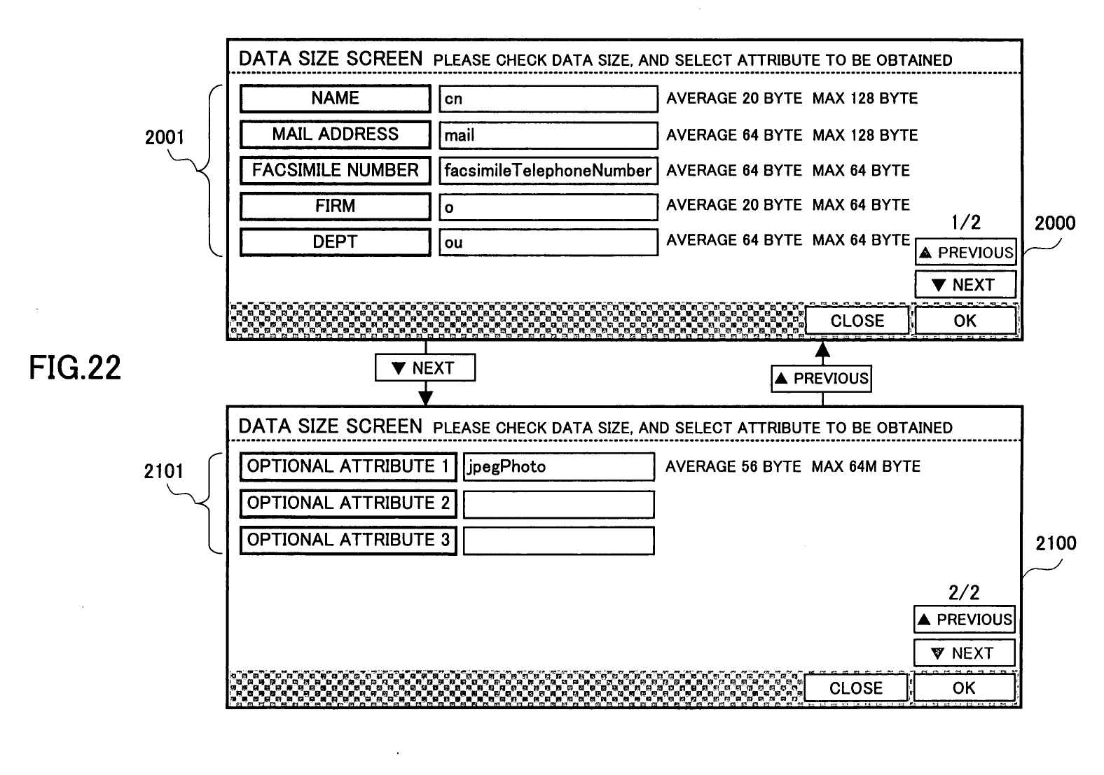

If a determination is made that the UCS 37 requires no more data size information (NO in step S608), process proceeds to step S609 in which the UCS 37 provides the already obtained data size information to the UCS client 200. Process proceeds to step S610 in which the UCS client 200 displays screens 2000 and 2100 as shown in FIG. 22 on the operations panel 80. FIG. 22 shows the transition of screens according to the sixth embodiment.

The screens 2000 and 2100 shown in FIG. 12 indicate the attributes, and the average and maximum data size associated with each attribute. The user can set the attributes whether to obtain or not by pressing buttons 2001 and 2101 to select one or more attributes.

Next, in step S611, the UCS client 200 determines whether any additional attribute is set as the one to be obtained, or any attribute which has been selected as the one to be obtained is set as the one not to be obtained. If a determination is made that one or more additional attribute is set as the one to be obtained or one or more attribute to be obtained is set as the one not to be obtained, (YES in step S611), process returns to step S600.

Otherwise (NO in step S611), the UCS client 200 proceeds to step S612 in which a LDAP server information setting request is sent to the UCS 37. The UCS 37 proceeds to step S613, and notifies the UCS client 200 whether the LDAP server information setting request has been processed successfully or not.

The present embodiment allows the user to perform the pre-retrieval thereby to check whether there is any attribute of which data size is larger than the reference data size before setting the attribute as the one to be obtained.

### Seventh Embodiment

According to the above embodiments, one or more attributes that requires long processing time or the data size of which is large are identified so that the processing time of LDAP retrieval be reduced. A seventh embodiment of the present invention may change the order in which attributes are obtained from the LDAP server 103, and separate retrieval requests are made to the LDAP server 103 so that the processing time of the LDAP retrieval is reduced.

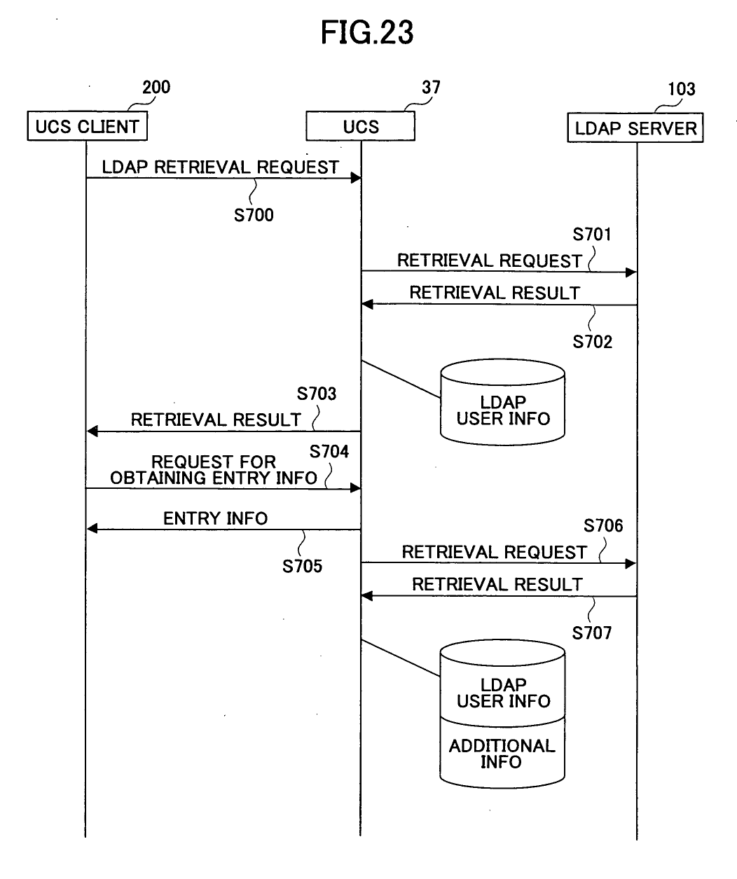

FIG. 23 is a sequence diagram showing exemplary LDAP retrieval according to the seventh embodiment. This LDAP retrieval can reduce time required until the LDAP retrieval result is displayed on the operations panel 80 by changing the order in which attributes are obtained from the LDAP server and separating the retrieval requests associated with the attributes.

In step S700, the UCS client 200 sends a LDAP retrieval request to the UCS 37. Next, in step S701, the UCS 37 sends a retrieval request based on the retrieval information provided by the UCS client 200 to the LDAP server 103 identified in the daps server information provided by the UCS client 200. Only attributes required for the LDAP retrieval result screen and attributes of which data size is a predetermined data size or less are obtained in step S701. Subsequently to step S701, the UCS 37 receives retrieval result in response to the retrieval request in step S702.

Next, in step S703, the UCS 37 follows procedure shown in FIG. 10, for example, to convert the data structure of an entry for the MFP 1 to the data structure of LDAP information, and provides the entry ID of the entry to the UCS client 200 as retrieval result. In step S704, the UCS client 200 sends a request for obtaining entry information to the UCS 37. In step S705, the UCS client 200 obtains entry information corresponding to the entry ID from the UCS 37. The attributes that the UCS client 200 obtains are those required for the LDAP retrieval result screen and those having data size equal to the predetermined data size or less. The UCS client 200 uses the attributes obtained in step S705 to display the LDAP retrieval result screen on the operations panel 80.

Next, in step S706, the UCS 37 sends a retrieval request for remaining attributes based on the LDAP retrieval request to the LDAP server 103 identified in the LDAP server information provided by the UCS client 200. The attributes that are retrieved in step S706 are those having data size equal to the predetermined data size or more. Process proceeds to step S707 in which the UCS 37 receives retrieval result in response to the retrieval request made in step S706.

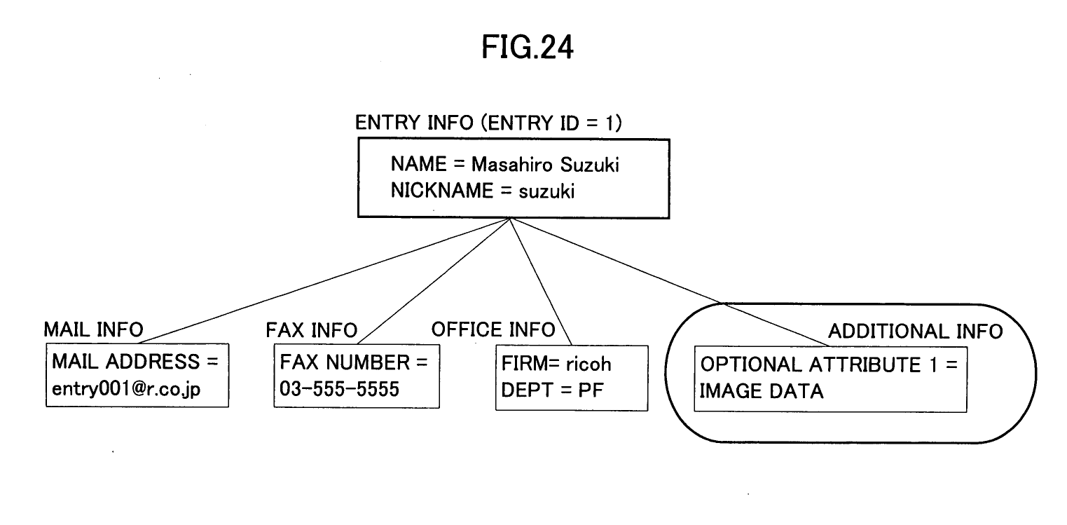

As described above, the attributes required for the LDAP retrieval result screen and the attributes only require short processing time are obtained first, and then, the LDAP retrieval result screen is displayed. The remaining attributes that require long processing time are obtained while the LDAP retrieval result screen is displayed. FIG. 24 shows the data structure for explaining the difference between the retrieval result obtained first and the retrieval result then obtained.

The LDAP user information shown in FIG. 24 includes entry information identified by the entry ID, and further includes mail information, facsimile information, office information, and additional information. The entry information, the mail information, and the facsimile information are obtained from the retrieval result in step S702. The additional information is obtained the retrieval result in step S707.

The time required until the retrieval result screen is displayed can be reduced because the order in which attributes are obtained from the LDAP server 103 is changed, and separate retrieval requests are sent to the LDAP server 103.

### Eighth Embodiment

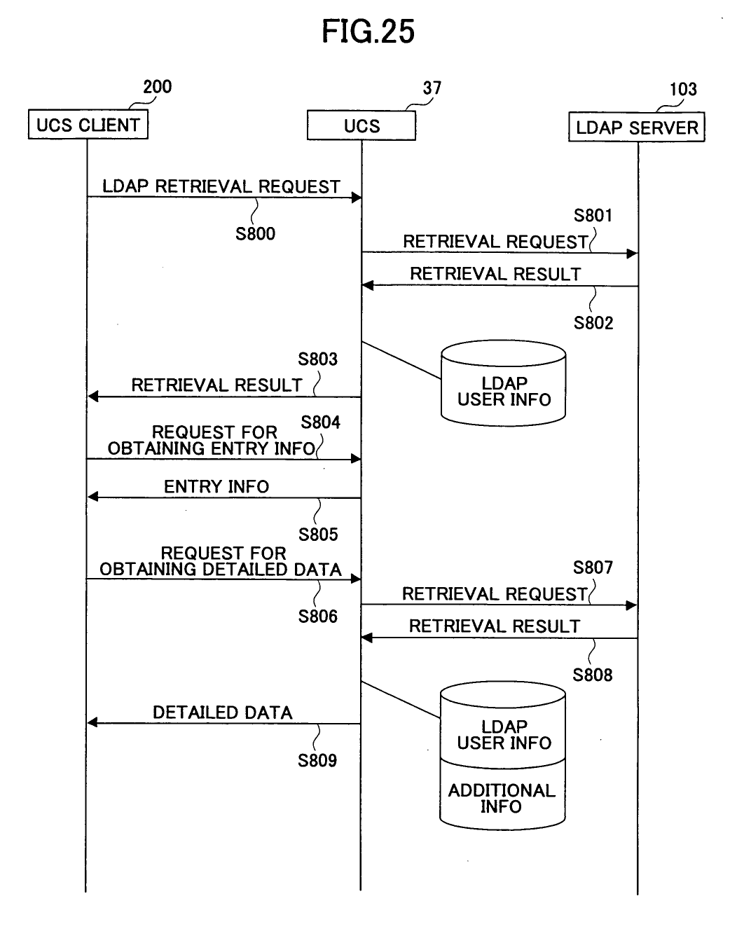

According to an eighth embodiment, the order in which attributes are obtained from the LDAP server 103 is changed, and remaining attributes are obtained after the user's additional request. FIG. 25 is a sequence diagram showing exemplary LDAP retrieval according to the eighth embodiment. As shown in the sequence diagram of FIG. 25, the order in which attributes are obtained from the LDAP server is changed, and remaining attributes are obtained, so that the time required for displaying the LDAP retrieval result screen can be reduced.

Steps S800 through S805 are identical to steps S700 through S705 shown in FIG. 23, and thus their description is omitted. In step S806, the UCS client 200 sends a request for obtaining detailed data to the UCS 37. That is, the UCS 37 does not perform the LDAP retrieval of the remaining attributes until the UCS client 200 sends the request for obtaining detailed data in step S806.

Upon receipt of the request for obtaining detailed data from the UCS client 200, the UCS 37 sends a retrieval request for the remaining data of the LDAP retrieval request received in step S800. It is noted that only attributes having data size equal to a predetermined data size or more are retrieved in step S807. Process proceeds to step S808 in which the UCS 37 receives retrieval result in response to the retrieval request made in step S807. Next, in step S809, the UCS 37 converts the data structure of the retrieval result received in step S808 into the data structure of the entry for MFP 1 following the procedure shown in the flowchart of FIG. 10, for example, and provides the converted retrieval result to the UCS client 200.

As described above with reference to FIG. 25, attributes required for displaying the LDAP retrieval result screen and attributes that requires short processing time are obtained first, and the LDAP retrieval result screen is displayed on the operations panel 80. The remaining attributes are obtained if specific request is made by the UCS client 200. Accordingly, if the user does not desire to obtain the remaining attributes, the user does not need waste time for obtaining the remaining attributes.

The eighth embodiment allows the user to change the order in which the attributes are obtained from the LDAP server 103, and to make separate request for retrieving the remaining attributes to the LDAP server 103 in order to reduce the time required for displaying the retrieval result screen.

The preferred embodiments of the present invention are described above. The present invention is not limited to these embodiments, but variations and modifications may be made without departing from the scope of the present invention.

This patent application is based on Japanese priority patent application No. 2004-000249 filed on Jan. 5, 2004, the entire contents of which are hereby incorporated by reference.

1. An information processing apparatus, comprising:
a retrieving unit configured to retrieve data from an external information storage server;
a setting unit configured to set a plurality of attributes so that said retrieving unit retrieves the plurality of attributes from the external information storage server; and
a converting unit configured to convert the data structure of the retrieved data into a data structure corresponding to the plurality of attributes.

2. The information processing apparatus as claimed in claim 1, further comprising a display unit configured to display the retrieved data,
wherein
said display unit displays at least one of processing time and information related to the processing time; and
said setting unit sets a subset of the plurality of attributes so that said retrieving unit does not retrieve the subset of the plurality of attributes from the external information storage server in response to a user's instruction.

3. The information processing apparatus as claimed in claim 2,
wherein
said display unit displays for each of the plurality of attributes, at least one of the processing time and the information related to the processing time.

4. The information processing apparatus as claimed in claim 2,
wherein
if at least one of the processing time and the information related to the processing time exceeds a threshold value, said display unit displays the at least one of the processing time and the information related to the processing time.

5. The information processing apparatus as claimed in claim 2, further comprising a storage unit configured to store at least one of the processing time and the information related to the processing time obtained from previous retrieval from the information storage apparatus;
wherein
if at least one of the processing time and the information related to the processing time stored in said storage unit exceeds a threshold value, said display unit displays the at least one of the processing time and the information related to the processing time.

6. The information processing apparatus as claimed in claim 1, further comprising a display unit configured to display the retrieved data; and
a storage unit configured to store at least one of the processing time and the information related to the processing time obtained from previous retrieval from the information storage apparatus;
wherein
if at least one of processing time and information related to the processing time stored in said storage unit of any one of the plurality of attributes exceeds a threshold value, said display unit displays the at least one of processing time and information related to the processing time of the one of the plurality of attributes that exceeds a threshold value for drawing a user's attention.

7. The information processing apparatus as claimed in claim 2,
wherein
said retrieving unit is further configured to perform pre-retrieval of data for the plurality of attributes, and
if at least one of the processing time and the information related to the processing time of any one of the plurality of attributes exceeds a threshold value, the display unit display the at least one of the processing time and the information related to the processing time of the one of the plurality of attributes that exceeds the threshold value for drawing a user's attention.

8. The information processing apparatus as claimed in claim 2,
wherein the information related to the processing time is data size.

9. The information processing apparatus as claimed in claim 2,
wherein the processing time includes at least one of average processing time per data item, maximum processing time per data item, and total processing time for a predetermined number of data items.

10. The information processing apparatus as claimed in claim 2,
wherein the information related to the processing time includes at least one of average data size per data item, maximum data size per data item, and total data size for a predetermined number of data items.

11. The information processing apparatus as claimed in claim 2,
wherein
if at least one of processing time and information related to the processing time of any attribute exceeds a threshold value, said display unit displays the attribute and the at least one of the processing time and the information related to the processing time of the attribute that exceeds the threshold value.

12. The information processing apparatus as claimed in claim 11,
wherein
said setting unit sets the attribute of which the at least one of the processing time and the information related to the processing time that exceeds the threshold value as the subset of the plurality of attributes so that said retrieving unit does not retrieve the attribute from the external information storage server in response to a user's instruction.

13. The information processing apparatus as claimed in claim 1,
wherein
said retrieving unit is further configured to retrieve data corresponding to the plurality of attributes that requires processing time shorter than a threshold time or that has data size less than a threshold data size, and then, retrieve data corresponding to remaining ones of the plurality of attributes.

14. The information processing apparatus as claimed in claim 1,
wherein
said retrieving unit is further configured to retrieve data corresponding to the plurality of attributes that requires processing time shorter than a threshold time or that has data size less than a threshold data size, and then, retrieve data corresponding to remaining ones of the plurality of attributes in response to a specific request from a user for the retrieval of the remaining ones of the plurality of attributes.

15. The information processing apparatus as claimed in claim 2,
the setting of the subset of the plurality of attributes is effective for one retrieval only.

16. The information processing apparatus as claimed in claim 2,
the setting of the subset of the plurality of attributes is effective from a next retrieval up.

17. The information processing apparatus as claimed in claim 2,
wherein
duration in which the setting of the subset of the plurality of attributes is effective is set in response to a user's instruction.

18. The information processing apparatus as claimed in claim 17,
wherein
once the duration in which the setting of the subset of the plurality of attributes is effective is set in response to a user's instruction, the duration can be set again in response to the user's further instruction.

19. A method of retrieving data stored in an external information storage server, the method comprising the steps of:
setting a plurality of attributes of the data so that the plurality of attributes is retrieved from the external information storage server;
retrieving the data from the information storage server; and
converting the data structure of the retrieved data into a data structure corresponding to the plurality of attributes.

20. A computer readable recording medium storing a computer program that, when executed by a computer, causes the computer to retrieve data stored in an external information storage server, the computer program comprising the steps of:
setting a plurality of attributes of the data so that the plurality of attributes is retrieved from the external information storage server;
retrieving the data from the information storage server; and
converting the data structure of the retrieved data into a data structure corresponding to the plurality of attributes.
